(19) United States
(12) Patent Application Publication
(10) Pub. No.: US 2009/0321987 A1
(43) Pub. Date: Dec. 31, 2009

(54) SEAT CUSHION USING VERTICALLY LAPPED FIBER

(75) Inventors: Julie L. York, Byron Center, MI (US); Gary W. Wolters, Zeeland, MI (US); Kenneth Assink, Holland, MI (US)

Correspondence Address: RANKIN, HILL & CLARK LLP, 38210 Glenn Avenue, WILLOUGHBY, OH, 44094-7808, US

(73) Assignee: ILLINOIS TOOL WORKS INC., Glenview, IL (US)

(21) Appl. No.: 12/552,848

(22) Filed: Sep. 2, 2009

Related U.S. Application Data
(62) Division of application No. 11/583,183, filed on Oct. 18, 2006.
(60) Provisional application No. 60/738,074, filed on Nov. 19, 2005.

(51) Int. Cl. B29C 45/14

(52) U.S. Cl. 264/257

(57) ABSTRACT

A seat cushion is disclosed that can be easily attached to, and removed from, a chair or seat utilizing a mesh seat bottom. The removable seat cushion includes a collection of downwardly extending engagement members that engage the mesh upon insertion through voids in the mesh. In certain applications, the seat cushion is formed from a vertically lapped fibrous batt.

### CROSS REFERENCES TO RELATED APPLICATIONS

This application claims priority upon U.S. provisional application Ser. No. 60/738,074 filed Nov. 19, 2005.

### BACKGROUND OF THE INVENTION

In the office landscape environment, much of the furniture, including chairs and seating units utilize a mesh or woven fabric supporting member as a seat bottom. While providing good aesthetic properties, mesh seating bottoms frequently suffer from limited comfort and cushioning qualities. Accordingly, there is a need for an improved seating system that can be readily used with such mesh seating bottoms.

Removable seat cushions are known in the art. These cushions typically include a padded member that can be placed on a seating surface. Although satisfactory in many regards, conventional seat cushions generally utilize a flat base member which does not conform to contoured seat bottoms used in many of today's office furniture. Accordingly, there is a need for a removable seat cushion that is readily adapted for use with a contoured seat.

Provisions are known in the art for attaching a seat or seat cushion to an underlying seat or chair. Such provisions include straps that are attached to one another such as by buckling, or tie downs that are secured to the underlying seat. It is often tedious and difficult to tie or otherwise secure such tie downs or snaps, and equally difficult to release them after use, in order to remove the seat cushion. Accordingly, there is a need for an improved strategy by which a removable seat cushion can readily be secured to an underlying seat or supporting surface.

Furthermore, fire retardancy is an increasing concern for office furniture. As efforts are underway by suppliers of office furniture systems and seating units to increase the degree of fire retardancy of such products, it would be desirable to also impart fire retardant properties to components used in conjunction with such products.

### BRIEF DESCRIPTION OF THE INVENTION

The present invention achieves all of the foregoing objectives and provides, in a first aspect, a furniture component comprising a frame member and a cushion member disposed on the frame member. The cushion member has first and second oppositely directed faces. The cushion member includes a region of vertically lapped fibers. The region extends generally across a face of the cushion member. At least a majority of the fibers in the region extend in a direction generally transverse to a face of the cushion member.

In another aspect, the present invention provides a removable seat cushion adapted for use with a chair having a mesh seat defining a collection of small apertures extending through the thickness of the seat. The seat cushion comprises a cushion member defining an upper surface and an oppositely directed bottom surface. The cushion member includes a region of a nonwoven mat of vertically lapped fibers. The seat cushion also comprises a frame component generally extending along at least one of the bottom surface of the cushion member, and the outer periphery of the cushion member. The seat cushion also comprises a collection of downwardly extending engagement members affixed to the frame component and adapted to releasably engage the mesh seat of the chair.

In yet another aspect, the present invention provides a method of forming a seat cushion having a region of vertically lapped fibers. The method comprises forming a frame component by placing a thin layer of a moldable polymeric material into a first mold and heating to thereby form the frame. The method also comprises positioning the frame in a second mold in conjunction with a collection of fasteners adapted to be molded to or otherwise affixed to the frame, and a layer of a nonwoven batt of vertically lapped fibers, and heating the frame, fasteners, and layer to thereby form an intermediate assembly. The method also comprises positioning the intermediate assembly into a third mold in conjunction with a layer of a covering material in position to cover a face of the intermediate assembly, and heating the intermediate assembly and covering material to thereby form the seat cushion.

### BRIEF DESCRIPTION OF THE DRAWINGS

The present invention will be described in detail with several preferred embodiments and illustrated, merely by way of example and not with intent to limit the scope thereof, in the accompanying drawings.

FIG. 1 is a perspective view of a typical chair utilizing a contoured mesh seat bottom.

FIG. 1A is a detailed view of a mesh material used in the seat portion of the chair shown in FIG. 1.

FIG. 2 is a view illustrating placement of a preferred embodiment seat cushion on the chair of FIG. 1.

FIG. 3 is an exploded view illustrating components of a preferred embodiment seat cushion.

FIG. 4 is a cross-sectional view of a cushion member of the seat cushion shown in FIG. 3 taken along line 4-4.

FIG. 5 is a cross-sectional view of a frame component taken across line 5-5 in FIG. 3, illustrating a preferred embodiment engagement member.

FIG. 6 is a view of another preferred embodiment engagement member used in the seat cushion described herein.

FIG. 7 is a view of another preferred embodiment engagement member.

FIG. 8 illustrates another preferred embodiment engagement member.

FIG. 9 illustrates yet another preferred embodiment engagement member.

FIG. 10 illustrates another preferred embodiment engagement member.

FIG. 11 illustrates yet another preferred embodiment engagement member.

FIG. 12 illustrates yet another preferred embodiment engagement member.

FIG. 13 illustrates another preferred embodiment engagement member.

FIG. 14 illustrates yet another preferred embodiment engagement member.

FIG. 15 illustrates a retainer component of another preferred embodiment seat assembly and a molding tool used to form the retainer.

FIG. 16 illustrates an intermediate assembly used in the preferred seat assembly referenced in FIG. 15, and a molding tool used to form the assembly.

FIG. 17 illustrates the preferred seat assembly referenced in FIGS. 15 and 16, and a molding tool used to form the final seat assembly.

FIG. 18 illustrates the various stages of manufacturing the preferred seat assembly and the molding tools used therefor.

FIG. 19 is a schematic cross section of a preferred embodiment seat cushion utilizing a region of a vertically lapped fibrous batt.

FIG. 20 is a schematic cross section of a preferred embodiment arm pad using a region of a vertically lapped fibrous batt.

FIG. 21 is a schematic cross section of another preferred embodiment arm pad, utilizing a major proportion of a vertically lapped fiber.

FIG. 22 is a side elevational view of a first side of a preferred embodiment seat assembly.

FIG. 23 is a view of a second side of the seat assembly depicted in FIG. 22.

FIG. 24 is a view of a third side, opposite the first side, of the seat assembly depicted in FIG. 22.

FIG. 25 is a view of a fourth side, opposite the second side, of the seat assembly depicted in FIG. 22.

FIG. 26 is a view of the top of the seat assembly depicted in FIG. 22.

FIG. 27 is a view of the underside of the seat assembly depicted in FIG. 22.

FIG. 28 is a perspective view of the seat assembly depicted in FIG. 22.

FIG. 29 is a side elevational view of a first side of another preferred embodiment seat assembly.

FIG. 30 is a side elevational view of a second side of the seat assembly depicted in FIG. 29.

FIG. 31 is a side elevational view of a third side, opposite the first side, of the seat assembly depicted in FIG. 29.

FIG. 32 is a side elevational view of a fourth side, opposite the second side, of the seat assembly depicted in FIG. 29.

FIG. 33 is a view of the top of the seat assembly depicted in FIG. 29.

FIG. 34 is a view of the underside of the seat assembly depicted in FIG. 29.

FIG. 35 is a perspective view of the seat assembly depicted in FIG. 29.

FIG. 36 is a side elevational view of a first side of another preferred embodiment seat assembly.

FIG. 37 is a side elevational view of a second side of the seat assembly depicted in FIG. 36.

FIG. 38 is a side elevational view of a third side, opposite the first side, of the seat assembly depicted in FIG. 36.

FIG. 39 is a side elevational view of a fourth side, opposite the second side, of the seat assembly depicted in FIG. 36.

FIG. 40 is a view of the top of the seat assembly depicted in FIG. 36.

FIG. 41 is a view of the underside of the seat assembly depicted in FIG. 36.

FIG. 42 is a perspective view of the seat assembly depicted in FIG. 36.

FIGS. 43 and 44 are views of a set of ring components arranged in a preferred pattern, prior to molding.

FIG. 45 is a side view of a preferred ring component after molding.

FIGS. 46 and 47 are views of the set of ring components depicted in FIGS. 43 and 44.

FIG. 48 is a view of the sides of the ring components shown in FIGS. 43-44 and 46-47.

### DETAILED DESCRIPTION OF THE PREFERRED EMBODIMENTS

The preferred embodiments relate to a seat cushion which utilizes one or more layers of a vertically lapped fiber. Such seat cushions also include a frame assembly and preferably, a collection of downwardly extending engagement members. The collection of engagement members are sized and shaped so as to releasably engage a mesh chair seat, as is frequently used in chairs designed for office and home environments.

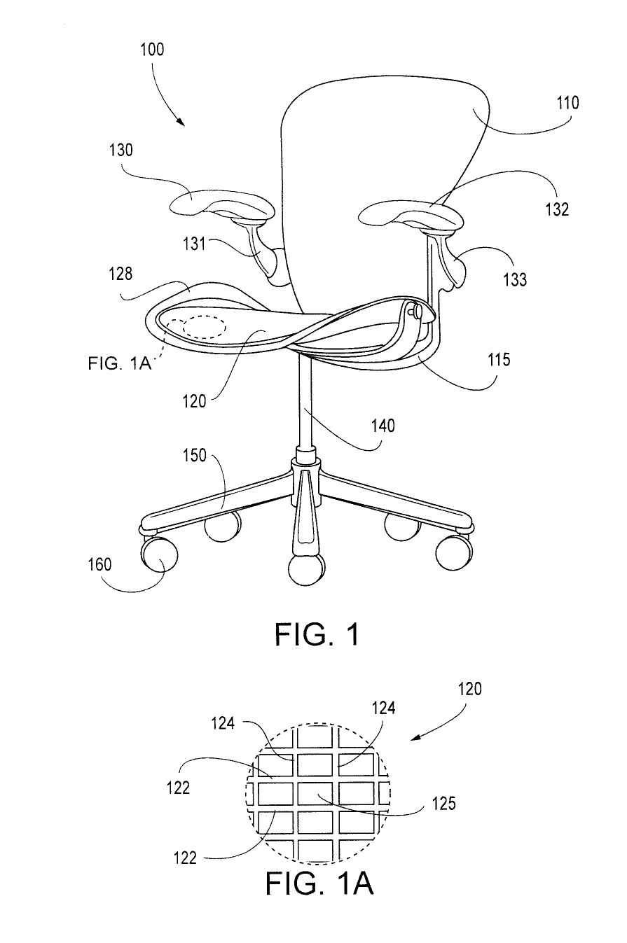

FIG. 1 illustrates a typical chair 100 with which the preferred embodiment seat cushions are used in conjunction. The chair 100 typically comprises a seat back 110 and seat bottom 120 and corresponding seat bottom frame 128 positionably coupled together by a frame assembly 115 extending therebetween. The chair 100 also comprises first and second arm members 130 and 132 engaged with the frame assembly 115 and/or the seat back 110 by support members 131 and 133, respectively. The sub-assembly of the seat back 110, seat bottom 120, frame assembly 115, and arms 130 and 132 is generally disposed and supported on a pedestal 140 extending between the frame assembly 115 and a base 150. The base 150 can be in a variety of different forms and arrangements, however, it is typical to utilize a plurality of outwardly extending support members each having a caster 160 or other rolling member disposed on their underside.

The seat bottom 120 of the chair 100 preferably utilizes a relatively thin supporting member such as a mesh or a woven fabric. The supporting member or mesh extends across the seat bottom frame 128 that imparts a contoured configuration to the mesh spanning that frame. The term “mesh” as used herein refers to any thin planar member having a plurality of small voids, apertures, holes, or openings extending through the thickness of the member. In the representative example shown in FIG. 1A, the mesh used in the seat bottom 120 includes a collection of parallel extending fibers or strands 122 and a second set of parallel extending fibers or strands 124 extending at right angles with the first set of fibers or strands 122. The sets of fibers or strands, i.e. 122 and 124, can be bonded to each other at their locations of intersection on contact, or remain unbonded. The resulting voids 125 defined at the intersections of these spaced fibers or strands can be in a variety of different shapes; and sizes. However, it is typical for the shape of a void 125 to be square or rectangular. The size of the void, or rather span or dimension of a void, is generally somewhat variable. The span may be significantly increased if the sets of fibers or strands such as 122 and 124 are not bonded to one another and forces or stresses urge the fibers apart from one another.

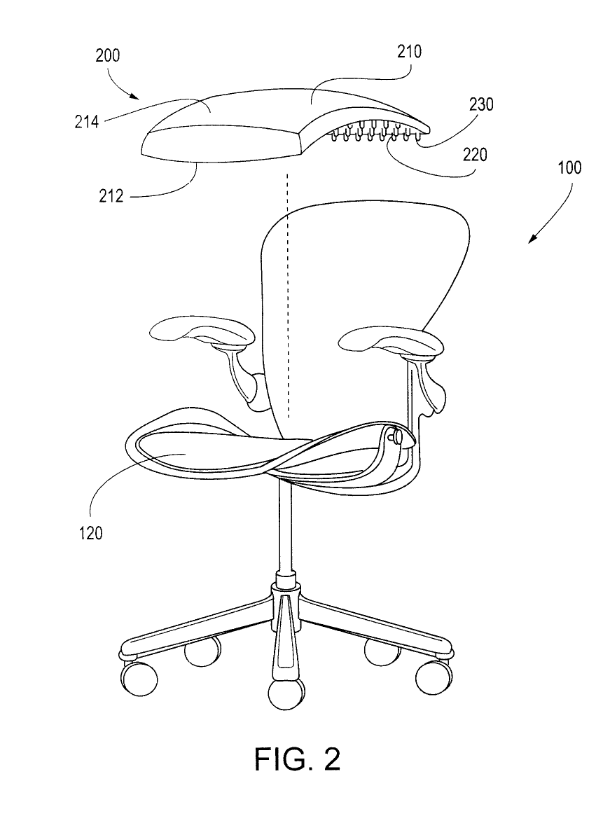

FIG. 2 illustrates positioning and placement of a preferred embodiment seat cushion 200 onto the chair 100 depicted in FIG. 1. The seat cushion 200 generally includes a cushion member 210 defining an upper surface 214 and an oppositely directed bottom surface 212. The seat cushion 200 also comprises a frame component 220 generally extending along the underside 212 and/or about the outer periphery of the cushion member 210. The frame component 220 includes a collection of downwardly extending engagement members 230 described in greater detail herein. The geometry and configuration of the underside of the seat cushion 200 is preferably shaped to conform with the geometry and configuration of the seat bottom 120 of the chair 100. However, the present invention includes seat cushions that do not exhibit such matching characteristics since the seat cushion 200 is preferably flexible and can be flexed or otherwise deformed to match the shape or contour of the seat bottom 120.

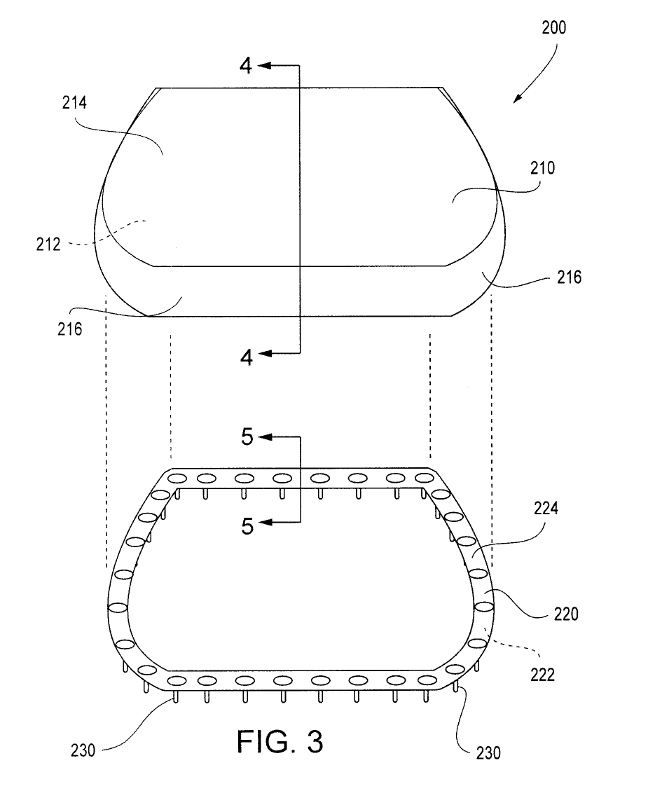

FIG. 3 is an exploded view of a preferred embodiment seat cushion 200. The seat cushion 200 includes a cushion member 210 having the noted upper surface 214 and bottom surface 212. The upper surface 214 and bottom surface 212 are generally separated by a laterally extending perimeter 216 extending around the perimeter of the cushion member 210. The seat cushion 200 also comprises a frame component 220. The frame component defines a top surface 224 and an oppositely directed under surface 222. Upon engagement of the cushion member 210 to the frame component 220, the topside 224 of the frame component 220 is preferably in contact and immediately adjacent to the bottom surface 212 of the cushion member 210. The frame member also includes a plurality of downwardly extending engagement members 230, described in greater detail herein.

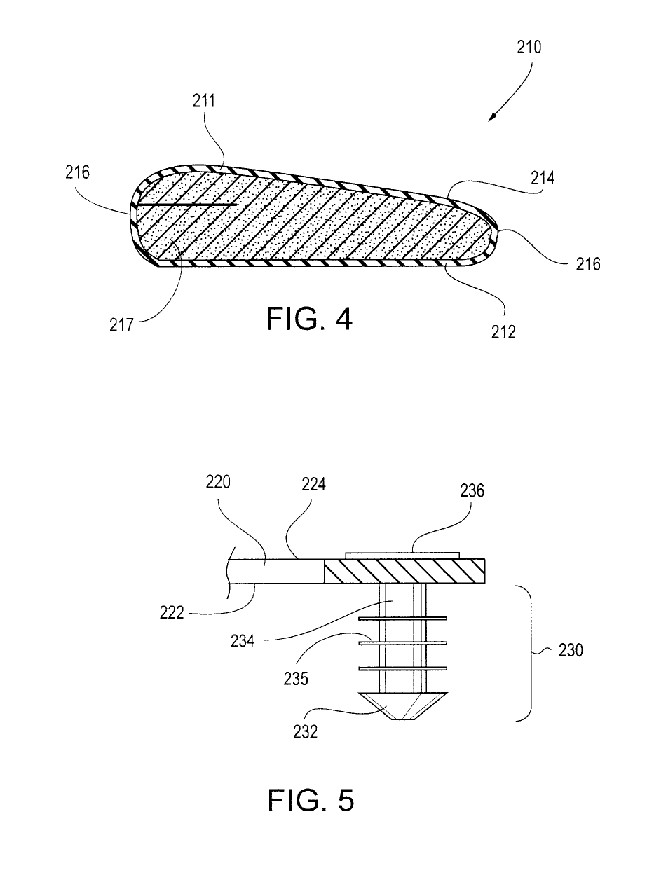

FIG. 4 is a cross-section of the cushion member 210 taken along line 4-4 in FIG. 3. The cushion member 210 includes a deformable interior member 217 generally surrounded by an optional protective covering 211.

The interior member 217 of the cushion member 210 is a unified or monolithic member and preferably includes a matrix fiber, a cellulose fiber, and a binder polymer that serves as an adhesive to bind the components together. The interior member 217 may also include various fillers and additional materials as well. The various components are assembled and melt-bonded together to form a finished member.

The matrix fiber for use in the interior member provides structure and strength characteristics to the cushion member. The interior member provides the structure to form the cushion member into the desired shape. The matrix fiber is preferably a high melting point polyester, polyethylene terephthalate (PET), or another thermoplastic. Any thermoplastic used as the matrix fiber should preferably have a melting point higher than the temperatures used in the molding of the interior member 217 as described below. That is, while it is acceptable for the matrix fiber used in the present invention to become soft during the molding process, it should not melt to the extent of becoming a molten component or losing its structure completely. More than one type of matrix fiber may be used in the construction of the cushion member 210. Alternately or in addition to the thermoplastic fiber, natural fibers could be used such as sisal, jute, kenaf, coconut fiber or hemp.

The cellulose fiber of the preferred embodiment cushion member is used to provide mass and shape to the interior member as well as contribute to its fire resistance. To increase its fire resistance, the cellulose is treated with a fire retardant in an amount necessary to render it nonflammable. Suitable fire retardants include, but are not limited to, boric acid and/or sodium polyborate. Suitable treated cellulose fiber for use in the present invention includes NU-WOOL®, available from Nu-Wool Co., Inc. and boron cellulose available under the tradename THERMOLOK INCIDE from Hamilton Mfg. Inc. The cellulose fiber preferably constitutes from about 40 to about 70% by weight of the cushion member, more preferably 45 to 55%.

The binder polymer of the interior member of the cushion acts as an adhesive and binder to bond the matrix fiber and cellulose fiber together and lock the fibers into position. Thus;, the binder polymer will at least partially melt during the molding process. The binder polymer can be any recyclable fiber having this characteristic, such as polyester, PET, polypropylene, polyethylene, nylon, PLA and acrylic. Preferably, the binder polymer is a polyester having a melting point of about 100° C. During the process, the binder polymer at least partially melts and becomes flowable, penetrating between the matrix fibers and the cellulose fibers to bond them together. Upon cooling, the binder polymer solidifies to form the final interior member.

In one embodiment of the present invention, the matrix fiber and the binder polymer are provided as a single bi-component blended fiber. In this bi-component fiber, the two materials may be arranged in co-axial arrangement, with an inner strand of higher melting point matrix fiber surrounded by a sheath of lower melting point binder polymer. Suitable polyester bi-component fibers for use in the present invention are commercially available under the trade designation “PET bi-component fiber” from various manufacturers. Various sized bi-component fibers may be used in the present invention seat cushion or products depending on the particular use. Although not intended to be limiting, a typical bi-fiber suitable for use in most applications of the present invention has a diameter of about 5 denier or smaller. When bi-component fiber is used, a preferred seat cushion interior member according to the present invention will contain about 30 to about 60% by weight bi-component fiber and about 40 to about 70% by weight cellulose. In any event, the amount should be enough such that the resultant member will pass ASTM E84 flame test for building materials and UL 723 test.

Most preferably, the interior member of the cushion member comprises from about 20% to about 40%, and most preferably about 30% of binder polymer, and from about 60% to about 80%, and most preferably about 70% matrix fiber.

Upon formation into the interior member, the member has a loft of about 0.300 to about 0.700, and preferably about 0.500.

The optional covering 211 of the preferred embodiment cushion member may be a layer made from any decorative membrane, including fiber and non-fiber materials and woven and non-woven materials. Additional filler materials may also be added to enhance strength or other panel characteristics, such materials including, but not limited l:o, various thermoplastics such as polyester, co-polyester, and nylon; natural materials such as sisal, hemp, cotton and flax; or other materials such as ceramic powder, fire-retardant materials, or metal mesh. Specialized additives may also be added to improve certain properties of the finished cushion member, including but not limited to, pesticides, anti-microbial additives, ammonia dust inhibitors, stabilizers, and water repellants.

The resulting cushion member such as 210, may be constructed using a conventional carding line and cross lapper in various arrangements. For convenience, a representative process will be described using a polyester bi-component fiber, cellulose and a finish layer only. As stated above, however, various other processes may be used to make the cushion member and additional fibers and additives may also be combined to produce the cushion member. The bi-component fiber is introduced on a garnett or carding machine, which straightens and parallelizes the loosened bi-component fiber to form a web of parallel, crimped fibers. As the bi-component fiber web exits the carding machine, the treated cellulose fiber is spread out over the top of the web. Any additional additives, such as pesticides, may be added at this stage or prior to the forming of the web. The resulting cellulose covered web is then directed through a cross lapper, to build up the web into a batt and to integrate the cellulose with the bi-component fiber. The resulting batt is cut to length and then heated, in an oven to melt the outer sheath of the bi-component fiber (the binder polymer) and cause it to intimately blend the cellulose and the inner strand of the bi-component fiber (the matrix fiber). This provides a “through-bonded” batt that not only bonds the components of the member, but also seals the surface of the batt against leakage. Any conventional carding machine and cross lapper may be used in this process. A suitable cross lapper is Crosslapper model CL-OC available from Technoplants. Additionally, other known processes for forming batts may be used, such as those disclosed in U.S. Pat. Nos. 5,974,631 and 6,276,028, the disclosures of which are incorporated herein by reference.

The batts are heated to a point where the binder polymer transitions from a solid state to a liquid state. Although the temperature at which the batts are heated will therefore vary depending on the composition of the matrix fiber and binder polymer, a typical heating cycle using a polyester bi-component fiber includes heating the batts to about 150° F. to about 375° F. Some of the binder polymer fibers may liquefy while others remain in a transition or gel-like condition. Thus, the batt becomes soft and pliable, yet can still be handled because the matrix fiber and cellulose retain enough of the batt structure. If the batts are to be molded into specific shapes to form a finished cushion member, the batts are transferred by a conveyor from the oven to a bonding press. If a finish layer is to be used in the manufacture of the cushion member, it is transferred, from a fabric carousel or other dispenser to the bonding press at this stage. The finish layer is mated and aligned with the hot batt and the press is then closed, capturing and pressing the finish layer to bond it to and embed it in the batt.

Regardless of whether a finish layer is used, the bonding press is closed and the batt is pressed, between the mold halves or dies of the press. The batt, still hot from the oven, assumes the shape of the interior of the press. The binder polymer may further transition to a molten state at this time due to the pressure of the press. The molten binder polymer flows throughout the mold cavity and binds the cellulose and matrix fibers together. If a finish layer is used, the molten material is also pressed into this layer, so it becomes at least partially embedded in the batt.

The mold halves or dies are preferably temperature controlled below the melting temperature of the binder polymer. Thus the oven heats the batt and the pressure of the closed mold in the press shapes the batt before the transfer of heat from the batt to the dies sets the batt in a solid state.

As discussed above, the binder polymer preferably at least partially melts to become a molten material during the heating in the oven. However, it preferably remains viscous rather than free-flowing. Thus, the binder polymer will only flow throughout the mold cavity when the press closes the mold and pressure is applied to the batt. Because of this, the final cushion member may have localized areas of relatively higher material density, and associated greater material toughness, where the added batt material was originally placed in the mold.

The cushion member may be constructed using a single batt or a combination of different batts having different compositions. Thus, a manufacturer can make cushion members having customized structures and properties based on a user's requirement. The combining of different batts allows a fabricator to tailor the characteristics of the resulting cushion member by positioning strata of component materials within the resulting cushion member. For example, a second batt comprised of a blend including a filler material may be used with a first batt to introduce and position a stratum of filler material into the resulting cushion member. The second batt may be assembled using the same process described above, with an exception that fibers of a filler material are included in the blend. The first and second batts may be introduced to each other before or after they are heated in the oven. Preferably, the two batts are introduced prior to heating, so that they may become at least partially bonded together during heating by the melting and diffusion of the binder polymer between the two batts.

As noted, it should be realized that a cushion member of the invention may be constructed with various alternative “lay-ups” of different fiber and filler layers and multiple batts prior to molding in the bonding press. By selecting different components for use in the batt or a multiple number of batts or by changing the thickness of each batt, one may alter the stiffness, toughness, acoustics and other characteristics of the resulting cushion member. For example, strength and other characteristics may be enhanced with the use of metal or ceramic fibers added to the batt. A rigid support structure, such as a metal mesh or foil, may be embedded in the cushion member for additional strength by including the structure in the batt or web lay-up.

Structural characteristics of the cushion member may also be controlled by adjustment of the material density and the mold pressure. For a given amount of material, a defined mold cavity volume will result in a particular material density. With a constant mold cavity volume, increasing the amount of material in the batt will increase the resulting density in the final cushion member. A cushion member with a relatively higher material density will exhibit a greater toughness that resists puncturing. Conversely, decreasing the amount of material in the batt will produce a cushion member with a relatively lower material density, resulting in a lighter, less tough cushion member susceptible to puncturing and the insertion of pins and the like. Thus, for example, a cushion member of the invention can be made to be a fully tackable member by reducing the resulting material density appropriately.

In a particularly preferred embodiment, either one or both of the cushion members and the frame component are formed from a nonwoven mat or batt of vertically lapped fibers. Such batts are commercially available such as for example, from Structured Fibres, Inc., of Saltillo, Miss. Another source of commercially available vertically lapped nonwoven fabrics, is Struto International, Inc., of Kings Mountain, N.C. Batts of vertically lapped fibers are unique because they include a significant proportion of fibers that extend in a vertical direction, i.e. in a direction generally transverse to the plane of the batt. Preferably, at least a majority proportion of the fibers in a mat or batt, extend in such a vertical direction. More specifically, it is preferred that for the fibers extending in a generally vertical direction, i.e. approximately transverse to the plane of the mat, at least 50% of the fiber length extends in such vertical direction. More preferably, at least 90% of the fiber length of such fibers extends in this direction. And, most preferably, at least 95% of the fiber length of such fibers extends in such direction. It will be appreciated that these are aspects of the mat prior to any compression or thermoforming. Batts featuring such a fiber orientation are able to provide a firmness generally not possible using a batt with a traditional horizontal orientation. Preferably, the vertically extending fibers are retained in position, within the mat, by an effective amount of a binder polymer, such as a lower melting point polyethylene. General background information as to manufacturing batts with significant proportions of vertically extending fibers is found in U.S. Pat. Nos. 5,618,364 and 7,011,181; both of which are hereby incorporated by reference.

As described in greater detail herein, batts of vertically lapped fibers are particularly useful in seating and arm pad applications. Vertically lapped fiber batts can be formed to provide components having the firmness characteristics such as typically required for arm pads and certain seating applications. Seating and arm pads can be formed from the batts of vertical lapped fibers. Seating and arm pad under-supports can also be formed from the vertically lapped fibers and can be used between a frame member and a covering layer.

The preferred embodiment seats, seat cushions, seating assemblies, arm pads, and other like components described herein can include one or more layers of a matt or batt of vertically lapped fibers. Generally, any type of fiber can be used, including synthetic fibers and natural fibers and combinations thereof. A wide array of fiber sizes can be used, such as from about 0.9 to about 300 denier, or more particularly from about 2 denier to about 15 denier. The resulting web or matt weight can range from about 100 g/m² to about 2000 g/m². If blends of fibers are used, as previously noted, thermobondable fibers can be used, such as from about 10 to about 100% of the total weight of fibers in the matt.

Preferably, the batt of vertically lapped fibers comprises a particular blend of fibers as follows. From about 5% to about 95% of a first fiber, or matrix fiber, and from about 95% to about 5% of a second fiber having a melting point less than the first fiber are used. Preferably, about 60% of the first fiber and about 40% of the second fiber are utilized. These percentages are percentages of the particular fiber based upon the total weight of the batt. The first fiber can be in a range of sizes, such as from about 0.9 denier to about 300 denier, with 15 denier being preferred. The second fiber can also be in a range of sizes, such as from about 2 denier to about 15 denier with 4 denier being preferred. The length of the second fiber is preferably from about 1 inch to about 3 inches, with 2 inches being preferred. The length of the first fiber is generally dictated by end use requirements.

The particular percentages or proportions of each of the first and second fibers in the batt of vertically lapped fibers can vary depending upon the characteristics desired for the final cushion product. Generally, the greater the proportion of the second fiber, i.e. the low melting point fiber, the firmer the resulting cushion. Conversely, a softer cushion can be formed by using less of the second fiber. Rebound characteristics of the cushion can also be improved by decreasing the proportion of the second fiber.

The frame component of the preferred embodiment seat cushions is preferably formed from the same materials as utilized for the interior member of the cushion member of the seat cushion. Generally, the materials for the frame component are selected, and used in such proportions, that the frame component is relatively rigid. The frame component preferably comprises from about 30% to about 100%, and most preferably about 70% of the binder polymer, and from about 70% to about 0%, and most preferably about 30% of the matrix fiber.

Although the frame component may be in a variety of different shapes, configurations, and dimensions, preferably the frame component is generally planar with a thickness of about 0.10 inch (about 0.25 cm) to about 0.010 inch (about 0.025 cm) thick, and most preferably about 0.050 inch (about 0.125 cm) thick.

After formation of the frame component, one or more of the engagement members are preferably molded thereon. Sufficient heat and pressure are utilized to bond the materials of the frame component and the engagement members together. Molding or attachment of the engagement members to the frame component can be performed in conjunction with affixment of the frame component to the cushion member. Optionally, the covering or cover layer of the cushion member can then be applied. Alternately, the covering can be applied prior to affixment of the frame component to the cushion member.

Most preferably, the molding or attachment of the plurality of engagement members is performed concurrently with the molding and formation of the interior member of the cushion member. That is, the interior member is formed and integrally molded on or about the frame component in conjunction with molding or attaching the engagement members to the frame component. This strategy eliminates a secondary or additional molding operation.

The engagement members can be formed from nearly any material. For example, the engagement members can be formed from the same material(s) as the cushion member and/or the frame component. Alternatively, the engagement members can be formed from a similar or different moldable polymeric material such as for example, polyethylene, polypropylene, polystyrene and the like.

FIG. 5 is a detailed partial cross-sectional view of the frame component taken across line 5-5 in FIG. 3. FIG. 5 illustrates a typical engagement member 230 extending from the under surface 222 of the frame component 220. The engagement member 230 detailed in FIG. 5 includes a distal tip member 232 and a shaft 234 extending between the frame component 220 and the distal member 232. One or more engagement flaps or projections 235 may be provided along the outer surface of the shaft 234. As described in greater detail herein, the engagement flaps or projections releasably engage a mesh material upon insertion through voids defined in that material. The engagement member 230 may extend through the frame component 220 and further be secured to the frame component 220 by a head component 236 which lies along the upper surface 224 of the frame component 220.

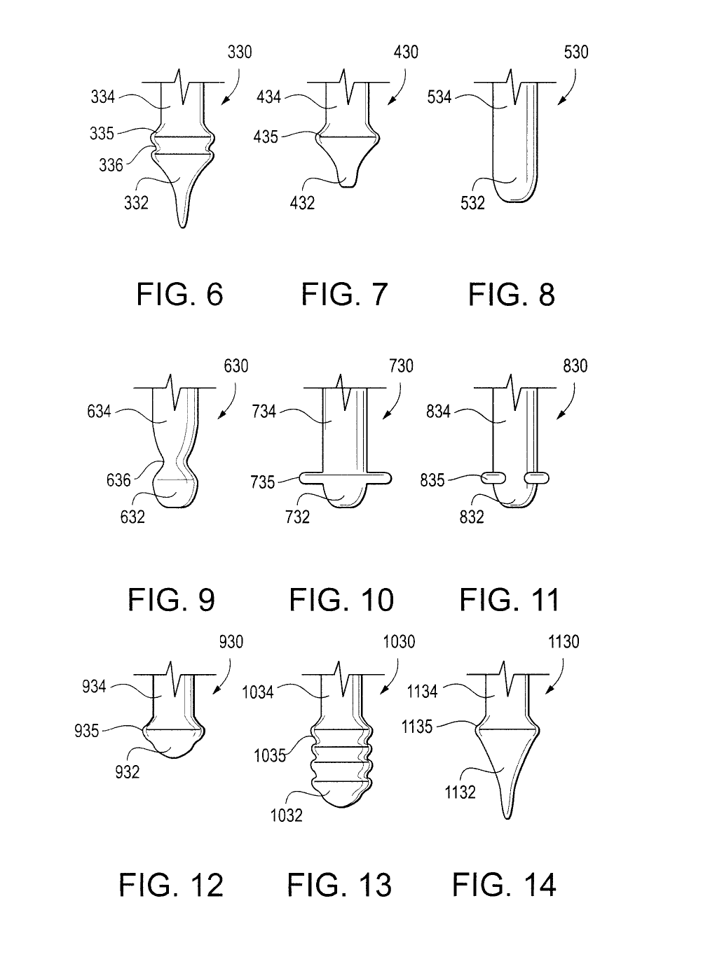

FIGS. 6-14 illustrate additional preferred embodiment engagement members having various profiles. FIG. 6 illustrates a preferred embodiment engagement member 330 having a tip 332 with a shaft 334 extending between the tip 332 and a corresponding frame component (not shown). The preferred embodiment engagement member 330 includes a plurality of outwardly extending projections 335 separated by a valley 336.

FIG. 7 illustrates another preferred embodiment engagement member 430. The engagement member 430 includes a tip 432 and a shaft 434 extending between the tip 432 and a frame component. The shaft includes an outwardly projecting member 435.

FIG. 8 illustrates another preferred embodiment engagement member 530. The member 530 includes a tip 532 and a relatively smooth shaft extending between the tip 532 and a corresponding frame component.

FIG. 9 illustrates another preferred embodiment engagement member 630. The member 630 includes a tip 632 and a shaft 634 extending between the tip 632 and a frame component. The preferred embodiment engagement member 630 is characterized by one or more depressions or valleys 636 defined along the shaft 634.

FIG. 10 illustrates another preferred embodiment engagement member 730. The engagement member 730 includes a tip 732 and a shaft 734 extending between the tip 732 and a corresponding frame component. The engagement member 730 includes one or more outwardly extending continuous projections 735.

FIG. 11 illustrates another preferred embodiment engagement member 830. The member 830 includes a distal tip 832 and a shaft 834 extending between a frame component and the tip 832. The engagement member 830 also includes one or more noncontinuous projections 835 extending outward from the shaft 834 and/or tip 832.

FIG. 12 illustrates yet another preferred embodiment engagement member 930. The engagement member 930 includes a distal tip 932 and a shaft 934 extending between the tip 932 and a corresponding frame component. The engagement member 930 includes one or more outwardly extending projections such as 935.

FIG. 13 illustrates yet another preferred embodiment engagement member 1030. The engagement member 1030 includes a distal tip 1032 and a shaft 1034 extending between a frame component and the distal tip 1032. The preferred embodiment engagement member 1030 includes a plurality of outwardly extending projections 1035.

FIG. 14 illustrates another preferred embodiment engagement member 1130. The engagement member 1130 includes a distal tip 1132 and a shaft 1134 extending between the tip 1132 and a corresponding frame component. The preferred embodiment engagement member 1130 includes a projection such as 1135.

Regardless of the specific form or profile of the engagement member, it is generally preferred that such member includes one or more outwardly extending engagement flaps or projections such as for example 235 shown in FIG. 5. Upon placement of the preferred embodiment seat cushion upon a mesh seat bottom of a chair, such as depicted in FIG. 2, one or more of the engagement members are inserted into, and through, the mesh material forming the seat of the chair. Specifically, the engagement members extend through voids or openings defined in the mesh. Utilizing a tapered distal end member such as member 232 in FIG. 5 facilitates alignment of the fibers, strands, or other material forming the mesh with the engagement member such that the engagement member can readily extend within an opening defined in the mesh. As the engagement member is displaced into the opening and past the mesh, the engagement flaps or projections, such as 235 in FIG. 5, preferably contact and engage portions of adjacent mesh material. This action is used to secure and retain the seat cushion upon the mesh seat bottom once placed thereon. The seat cushion can be easily removed from the seat bottom by simply displacing the cushion away from the seat bottom. The engagement flaps or projections readily deform to allow adjacent mesh material to pass by. Although the preferred embodiment seat cushion includes a collection of engagement members having flaps or projections, the invention includes engagement members free of such structures, such as the engagement member 530 shown in FIG. 8.

In one embodiment, and referring to FIGS. 2-3, a thin seat cushion or pad 200 is secured over one or both of the seat and back seating structure. Preferably, the thin pad is a molded batt or panel material, as disclosed for example in US Patent Application Publication US 2004/0028958 A1 (U.S. application Ser. No. 10/463,187), PCT Application PCT/US01/10262 (Publication No. WO 01/74583 A1), U.S. Provisional Application No. 60/193,196, U.S. Provisional Application No. 60/389,647, U.S. application Ser. No. 09/869,418, PCT Application PCT/US00/32272 and U.S. Provisional Application No. 60/167,303, all of which are hereby incorporated herein by reference. In particular, the pad includes a layer of moldable material 217 and a finish material 211, such as a fabric, secured or disposed along one side of the moldable material.

The thin pad can be formed in a three-dimensional shape to mate with and conform to the upper, body-facing surface of a seating structure, whether it be the back or seat. As previously noted, in one embodiment, the moldable material is made of a non-woven material, and can include without limitation thermoplastics, polyester, co-polyester, polypropylene, nylon, polyethylene, or combinations thereof. For example, one suitable non-woven material is available from western Nonwovens, Los Angeles, Calif. The finish, e.g. fabric, is bonded to the moldable material substrate with an adhesive, for example and without limitation a powder adhesive, including for example, and without limitation a co-polyester resin available from EMS-Griltech, South Carolina. Alternatively, the fabric is simply embedded into the moldable material substrate. In certain embodiments, the overall pad preferably has a thickness of 0.10 inches (0.25 cm) to about 0.75 inches (1.9 cm), or 0.20 inches (0.5 cm) to about 3.0 inches (7.6 cm) and in one embodiment is about 0.25 inches (0.66 cm) when covering the back and about 0.50 inches (1.3 cm) when covering the seat. The pad is relatively thin, such that it is flexible and can flex and conform to the underlying seating structure.

Referring to FIGS. 3-5, a seat pad assembly 200 is shown as including a frame or rim component 220, a pad component 217 and a fabric covering component 211, or finish material. The rim component 220 is formed by placing a thin layer of a moldable polymeric material such as a polyester material into a first mold. The mold heats and preferably compresses the polyester material and creates a rigid rim in the general shape of the perimeter of the seat or back. The mold further forms a plurality of openings spaced around the rim component.

The rim component is then placed in a second mold. Fasteners 230, such as Christmas tree fasteners include a one-way insert portion such as distal member 232 in FIG. 5, that are inserted in the openings of the rim. The term “one-way” insert portion means the fastener can be easily inserted in one direction, but cannot be easily removed in the other, opposite direction.

Additional moldable material such as polyester material, preferably in the form of a layer, is placed in the second mold on top of the rim. The moldable material can include partially, or in its entirety, the previously described vertically lapped fibers or nonwoven batt thereof. The pad component 217 is formed and bonded to the rim component 220 with heat. The fasteners 230, can include a top flange component 236, are trapped or secured/in-molded between the rim component and pad component. The second mold further trims or cuts the perimeter of the pad component. By making the rim component 220 separately from the pad component 217, the rim component can be made more rigid such that it can support the fasteners 230.

Next, the bonded rim and pad components 220, 217 are inserted into a third mold. A powder adhesive is added to the top of the pad component and a fabric covering is placed over the top of the pad component. The mold heat cures the fabric 211 onto the pad component 217. The mold further forms the shape of the pad around the edge thereof, for example by forming a radius or curve to the edge. The mold can further form embossments resembling a plurality of inwardly extending or outwardly extending geometric characters such as dimples, in the top of the pad assembly. In one embodiment, the geometric characters are formed by using pins.

After the pad assembly is removed from the third mold, the fabric 211 is trimmed and wrapped around the bottom of the assembly where it is secured with adhesive. The pad can be secured to an underlying support member by placing the support member in a die, which stamps or forms a plurality of openings shaped and dimensioned to receive the one-way insert portion of the fasteners. The pad assembly 200 is then secured to the support member by inserting the fasteners into the openings with a one-way attachment and pressing the pad assembly and seat support together.

Rather than the exemplary geometric characters, other markings, signage or indicia can be embossed into the chair seat and/or back, including for example and without limitation the name of a business, department or individual, or other designs.

When forming a seat cushion from the previously described nonwoven batt of vertically lapped fibers, a preferred method is as follows. The seat cushion can be formed by employing a modified thermoforming process in which a heated tool is used to compress and create select regions of varying strength and rigidity within the seat cushion. The tool serves to emboss or compress the fiber batt in only desired regions. The tooling is configured such that it controls the areas at which embossing occurs. Those regions of the batt which are not contacted by the heated tool retain their cushioning characteristic.

As noted, the tool is heated. Although the particular temperature of the tool varies depending upon the specific materials in the batt, and primarily with regard to the second fiber, an approximate temperature range for the tool is from about 150° F. to about 375° F. and preferably about 200° F. to about 325° F. It will be appreciated that if lower temperatures are to be used for the heated tool, the holding times can be increased to promote heat transfer from the tool to the batt and fibers therein. Generally, exemplary heating hold times are in the range of from about 60 seconds to about 90 seconds. However, it will be appreciated that the present invention includes the use of shorter or longer hold times. Also, it is significant and preferred that the tool(s) or mold(s) themselves are heated to thereby heat their contents. Thus, it is preferred that at least one mold set utilize a direct heating strategy, and most preferred that all molds or mold sets use a direct heating strategy. As will be appreciated, a direct heating strategy can be performed by using tool(s) with heating passages in which a heating fluid can pass. Alternately, electrically heated tool(s) could be used.

During application of the heated tool to the nonwoven batt of vertically lapped fibers, it is preferred to apply the tool with a compressive force, onto the batt. Generally, such pressures range from about 15 psi to about 25 psi. Again, the present invention includes the use of greater or lesser pressures.

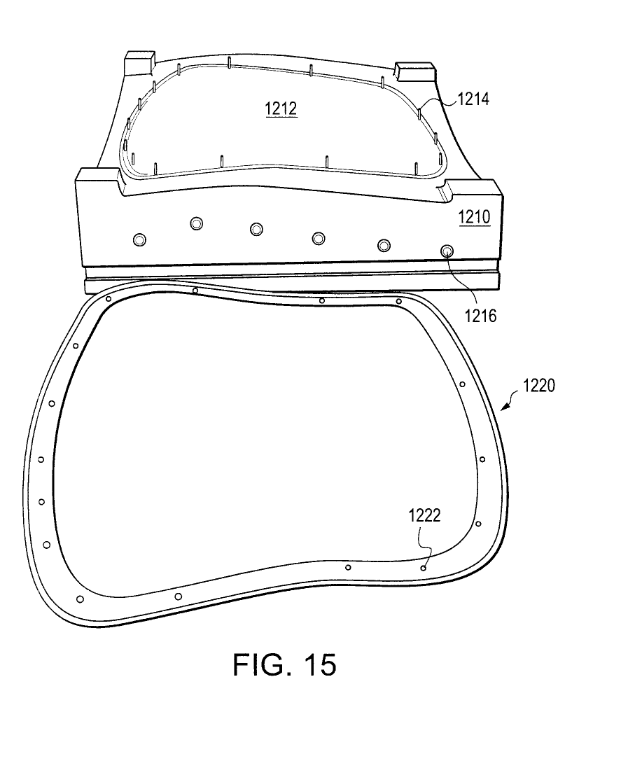

An exemplary embodiment process for forming a preferred embodiment seat cushion using vertically lapped fibers is depicted in FIGS. 15-18 as follows. FIG. 15 illustrates a ring or retainer component 1220 formed from a tool assembly 1210. The tool assembly 1210 defines a molding surface 1212 which is preferably contoured according to the desired shape of the seat to be produced. A collection of upwardly projecting locator tabs 1214 extend around the perimeter of the molding surface 1212 of the tool 1210. The tool 1210 can also include one or more heating provisions 1216 such as electrical heating members or alternatively, channels for the passage of heating fluid. The ring 1220 is preferably formed by placing one or more sections or pieces of a material to be heated and/or molded on the tool 1210, and specifically on the molding surface 1212 and preferably adjacent to the locator tabs 1214. Generally, three or four loose sections of material forming ring 1220 are placed on the molding surface 1212 and alongside and around the perimeter of the molding surface 1212. A corresponding half of the tool assembly (not shown) is then placed over the ring components and in engagement with the tool 1210 and the resulting assembly is heated to thereby compress and thermally bond the material and form a unitary rigid structure for the ring 1220. One or both of the mold halves such as tool 1210 can include projections that form apertures 1222 in the ring 1220.

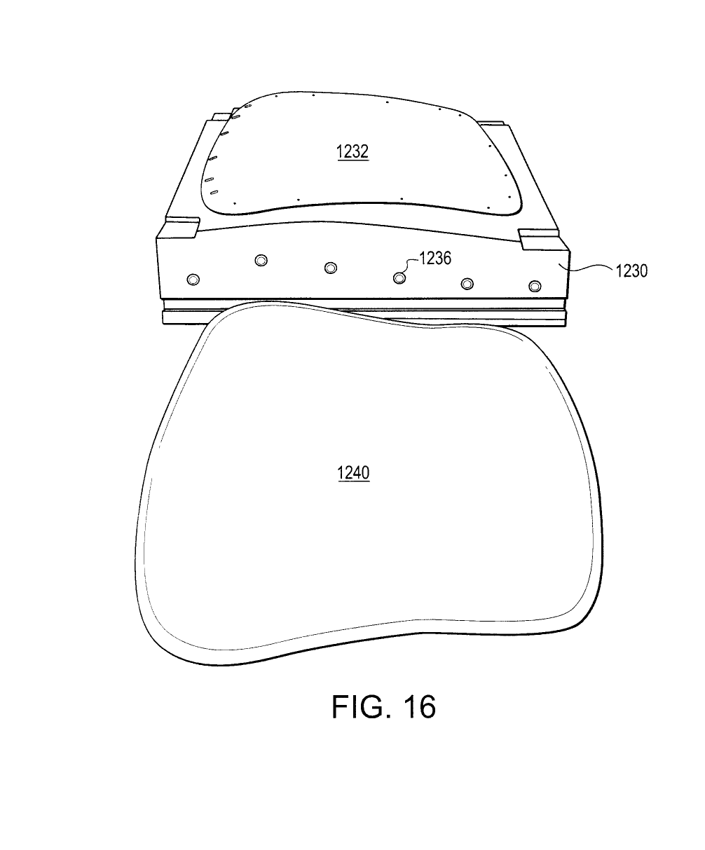

FIG. 16 illustrates formation of an intermediate assembly of the preferred seating cushion. The intermediate assembly is designated as 1240 and is formed from placing a completed ring assembly 1220, as previously described, in another tool or die assembly 1230 and specifically on a molding surface 1232 of the tool 1230. The tool 1230 may include one or more heating provisions 1236. On top of the ring 1220 placed on molding surface 1232 of the tool 1230, a layer of a moldable batt or other material, preferably a PET thermoformable material, is positioned. A corresponding top portion (not shown) of the molding assembly 1230 is then lowered onto the layered assembly and the assembly is heated and/or compressed to thereby thermoform the PET or other batt material. The heating and compression operation forms the collection of materials into the desired shape, generally dictated by the contour of the molding surface 1232, and also bonds the layer of the moldable batt onto the ring 1220 to thereby form the intermediate assembly 1240.

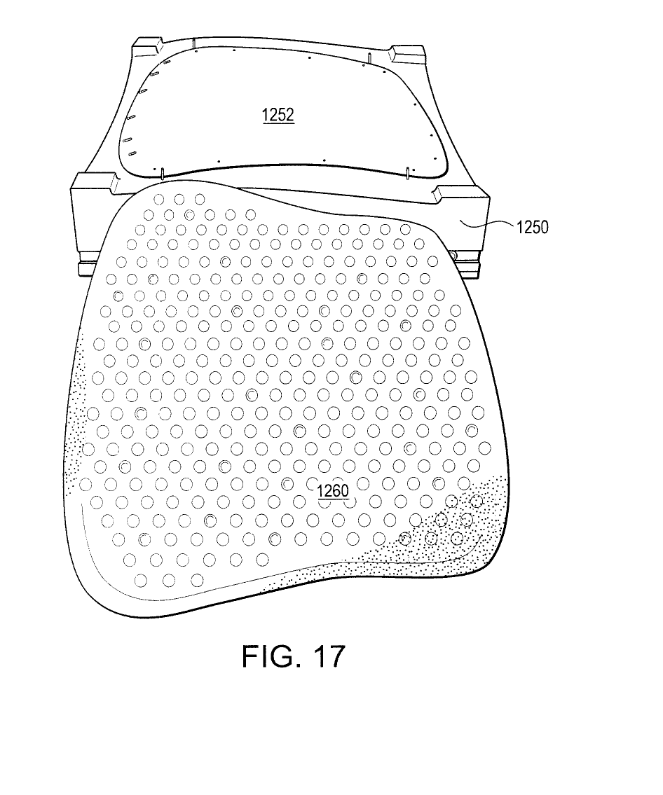

FIG. 17 illustrates completion of a final preferred seat member as described herein using a layer of a vertically lapped fiber batt. The completed seat member is designated as 1260 in FIG. 17 and also includes a layer of a decorative fabric disposed along its exterior. In forming seat member 1260, another tool or die assembly 1250 is shown which defines a molding surface 1252. The seat member 1260 is formed by placing the intermediate assembly 1240 such as shown in FIG. 16, onto the molding surface 1252 of the third molding assembly. Next, a layer of the vertically lapped fiber is then placed onto the intermediate assembly 1240, and a layer of a fabric or other decorative covering material is placed onto the relatively loose batt of the vertically lapped fiber layer. A corresponding half (not shown) of the tool or die assembly 1250 is then placed thereon and engaged with the tool 1250 to compress and partially heat the resulting assembly to thereby form the final seat member 1260 as shown in FIG. 17. Preferably, in using the third tool or die assembly 1250, only the upper die member (not shown) is heated. Therefore, preferably, the lower or bottom portion of the tool or die assembly 1250 is not heated. This is to ensure that the vertically lapped fiber portion of the seat member 1260 is not excessively heated which would otherwise reduce its cushioning characteristics. In FIG. 17, a pattern of dimples or recessions is noted as defined along the outer surface of the seat member 1260. Although not a requirement according to the present invention, such pattern can be formed by providing the molding surface in the upper tool or die member of the assembly 1250 with a collection of outwardly extending projections in the desired pattern.

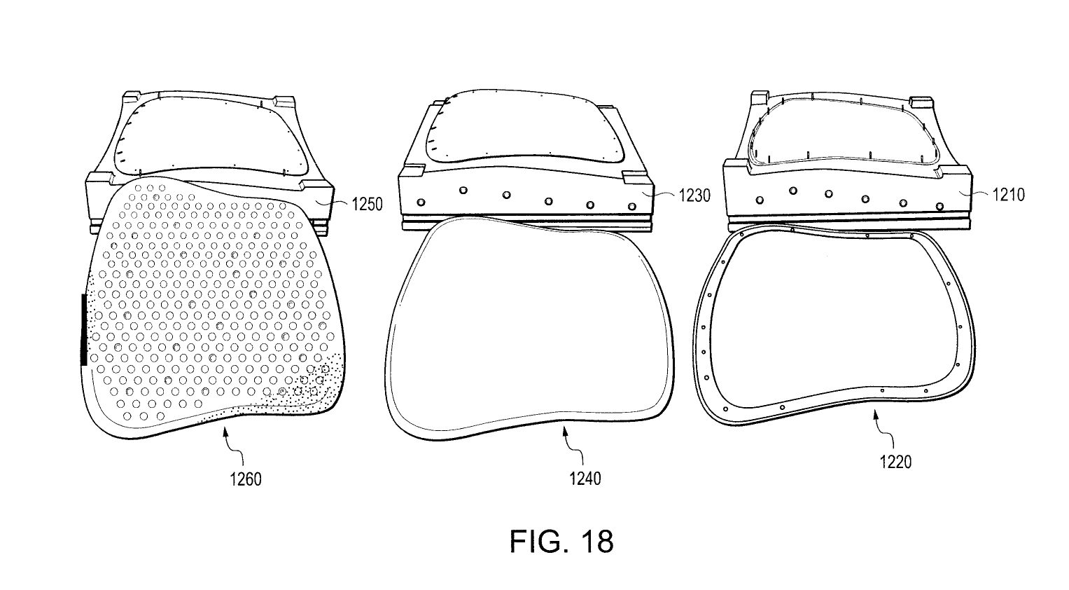

FIG. 18 illustrates the previously noted components of ring or retainer 1220, the intermediate assembly 1240, and the final seat member 1260, alongside their respective molding assemblies, 1210, 1230 and 1250.

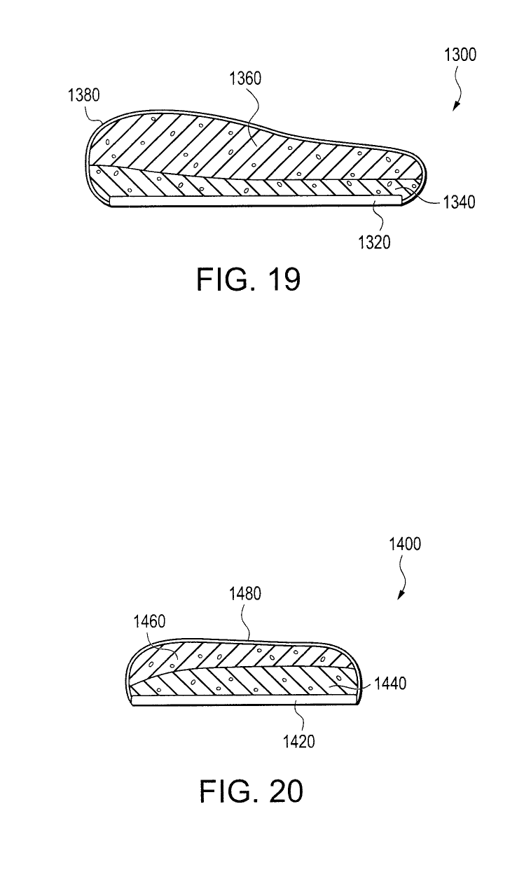

FIG. 19 is a schematic cross section of a preferred embodiment seat cushion 1300 utilizing a region of a vertically lapped fibrous batt. The seat cushion 1300 corresponds to the seat member 1260 produced as depicted in FIGS. 15-18. The cushion 1300 includes a ring component 1320, an intermediate support and cushioning layer 1340, a region of a vertically-lapped fibrous batt 1360, and a layer of a fabric or outer covering 1380 extending about the periphery of the layered assembly 1320,1340, and 1360, which as noted is preferably thermoformed.

It will be understood that the preferred embodiment seat cushions or other furniture components utilize a region of vertically lapped fibrous batt, either alone or in combination with one or more regions of cushioning layer(s).

FIG. 20 is a schematic cross section of a preferred embodiment arm pad 1400 in accordance with the present invention. The arm pad 1400 comprises a support or base member 1420, similar to the ring 1320, an intermediate support and cushioning layer 1440, and a region of a vertically lapped fibrous batt 1460. The layered assembly is preferably covered with an exterior cover 1480, such as a fabric or other layer.

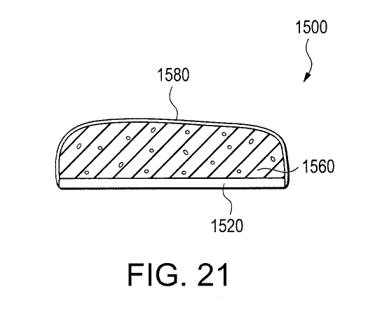

FIG. 21 is another schematic cross section of another preferred embodiment arm pad 1500. The arm pad 1500 comprises a base member 1520, and a region of vertically lapped fibrous batt 1560 disposed thereon. The resulting assembly is covered with an outer layer 1580.

The arm pads 1400 and 1500 are preferably thermoformed and using the previously noted temperatures and pressures to form the arm pads in the desired shapes.

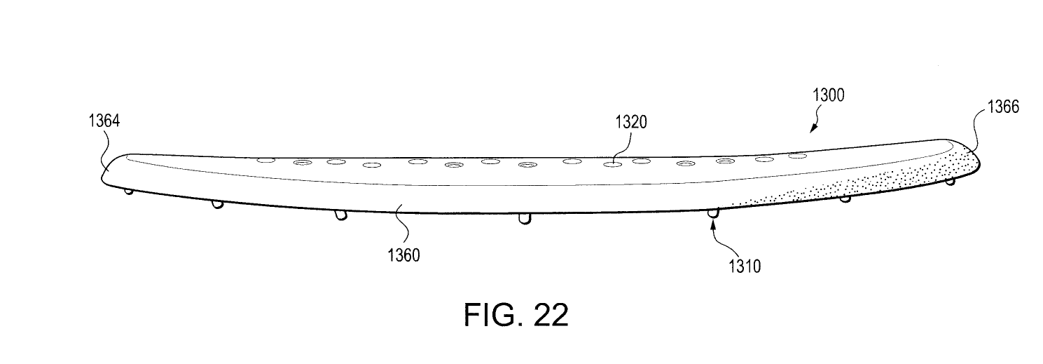

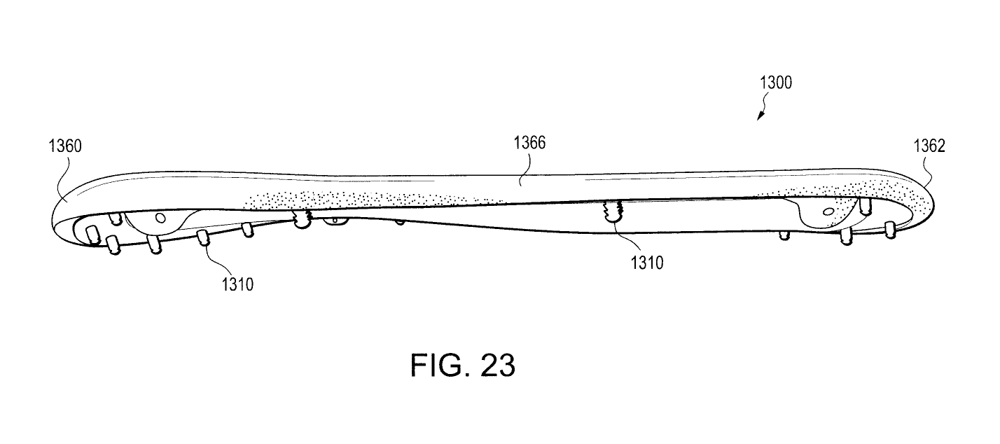

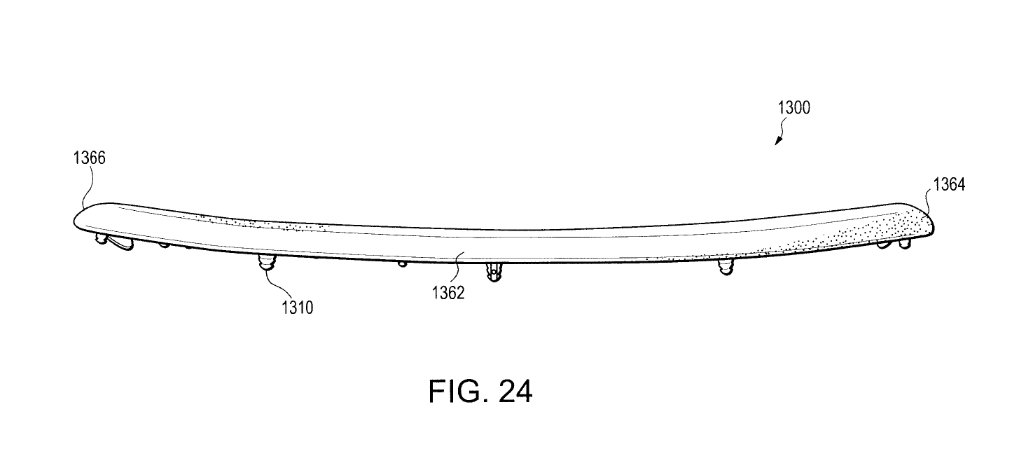

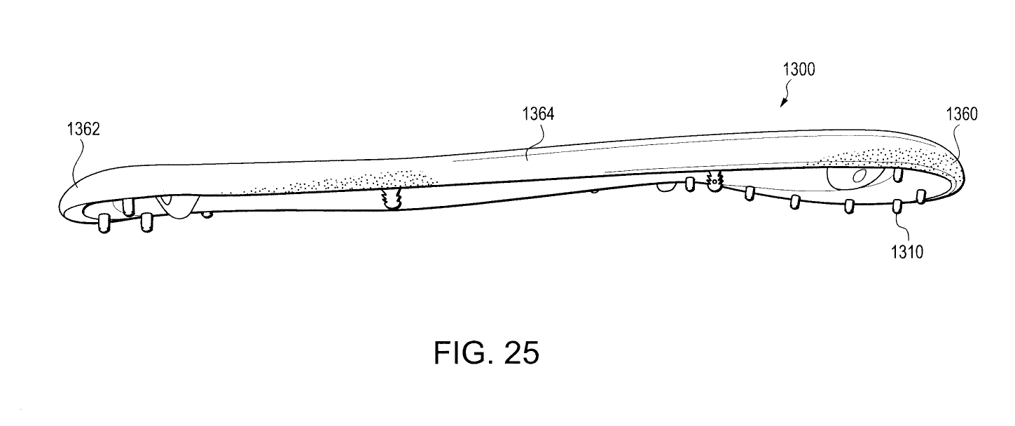

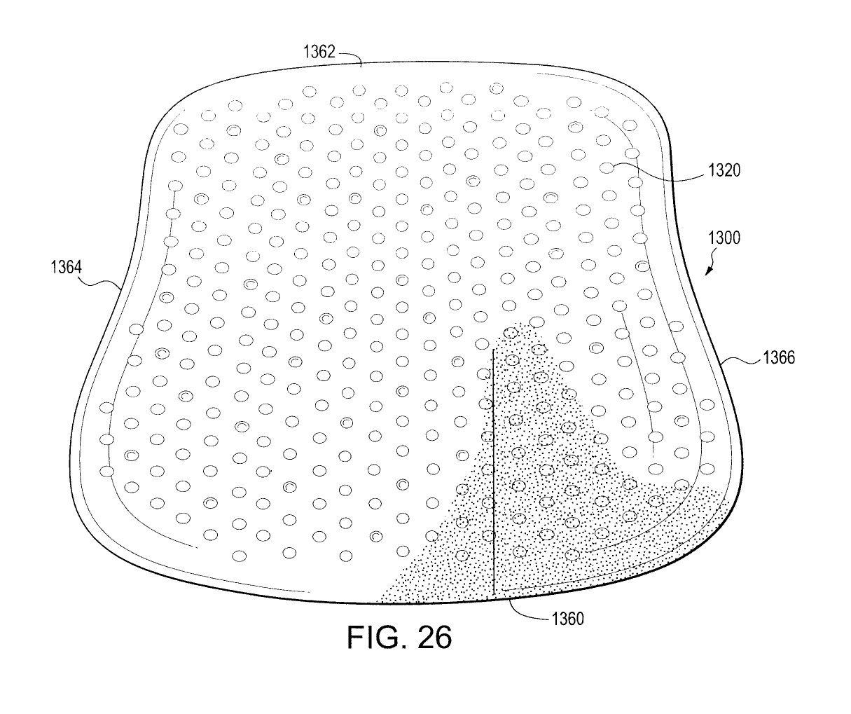

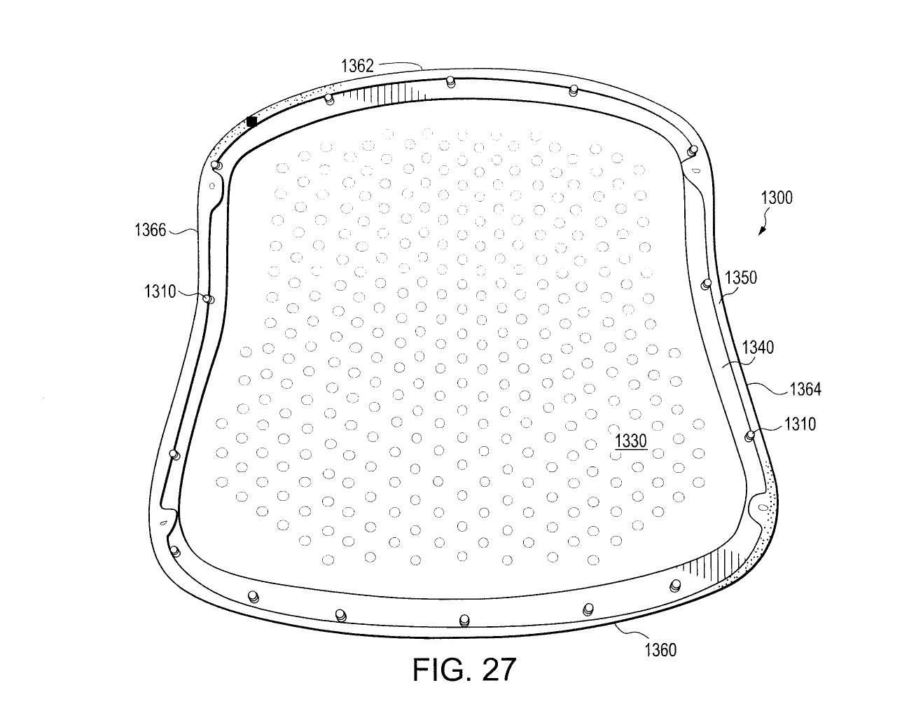

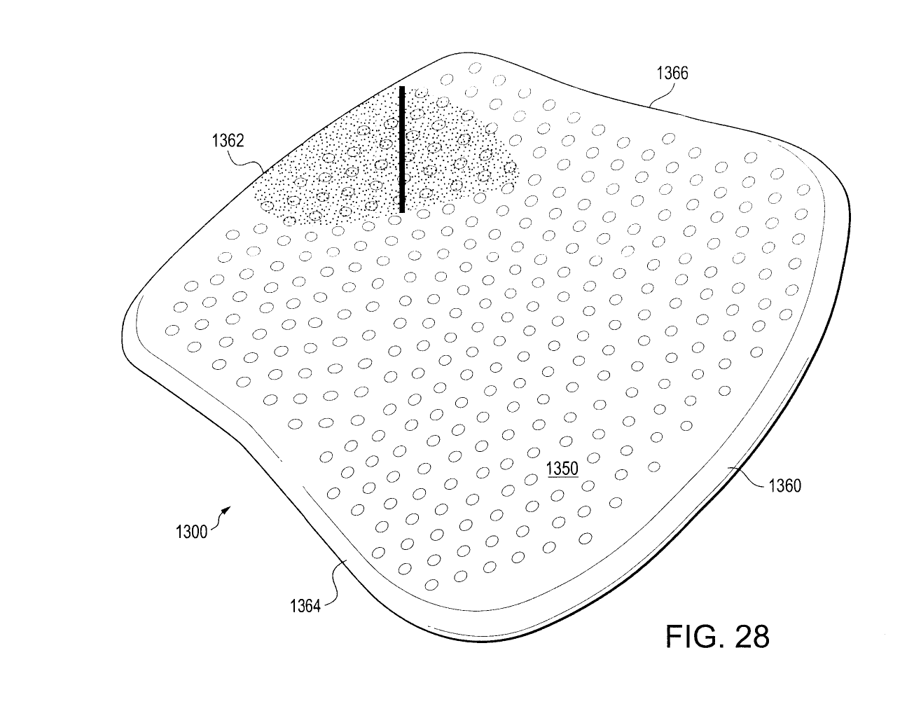

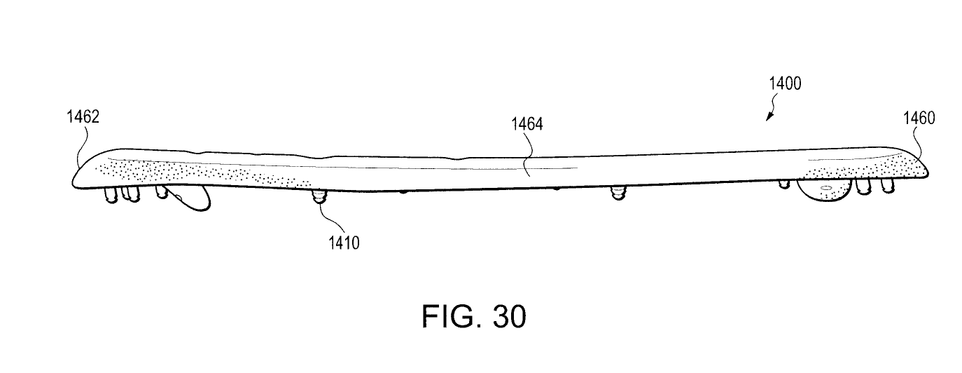

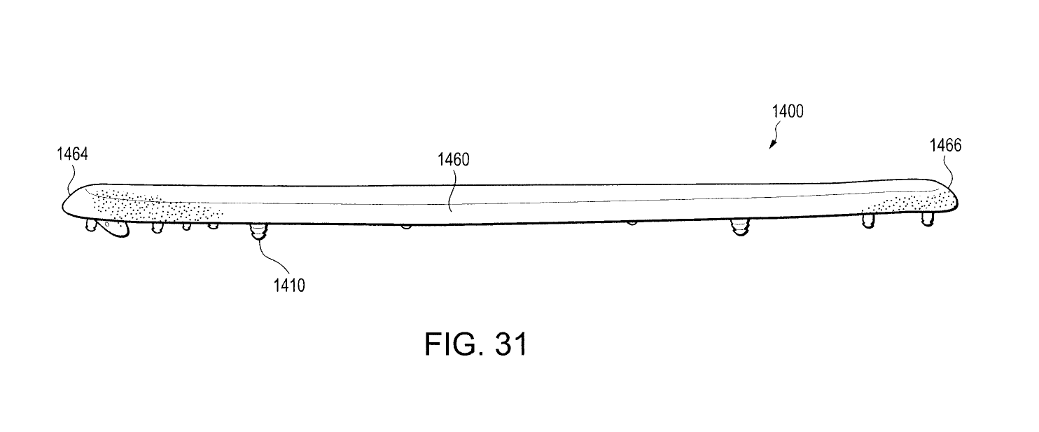

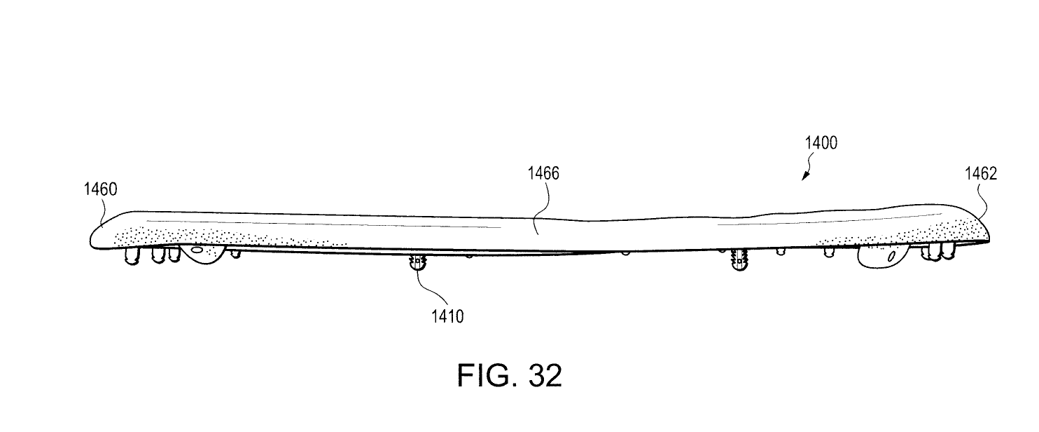

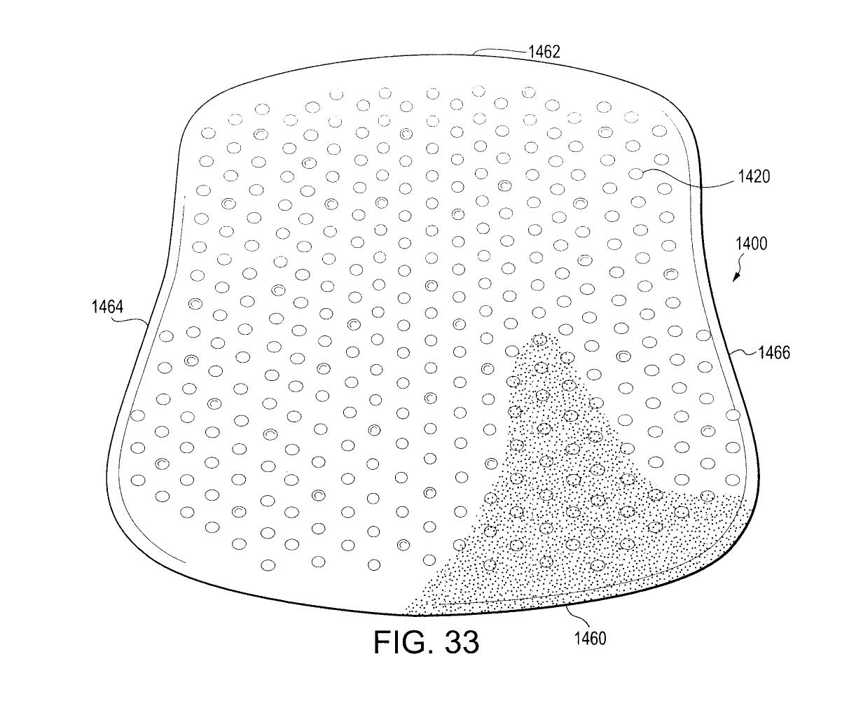

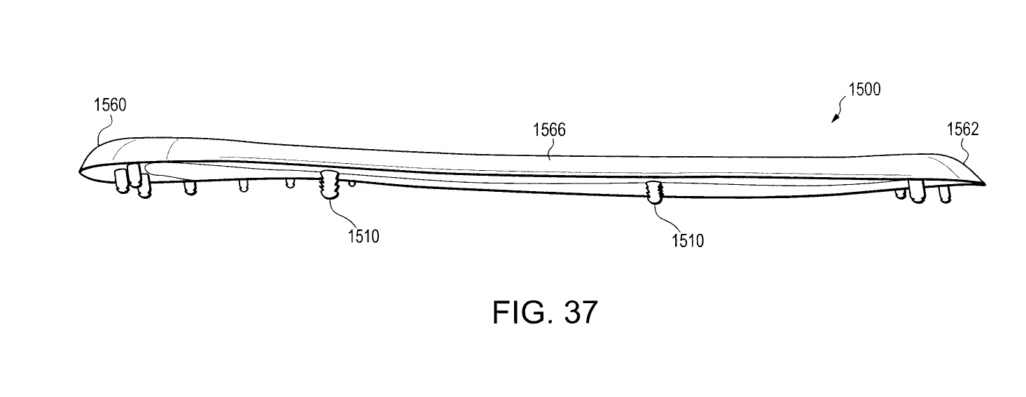

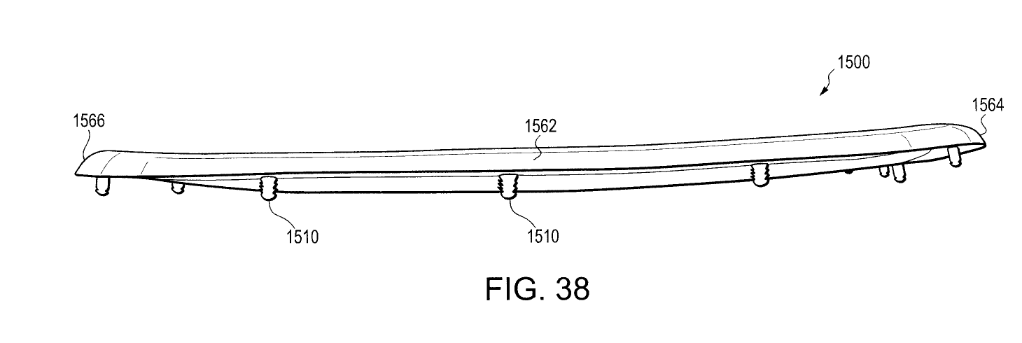

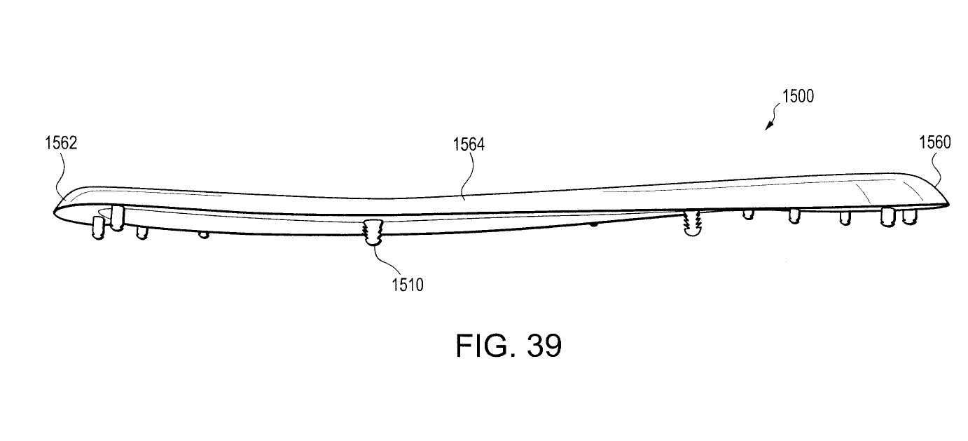

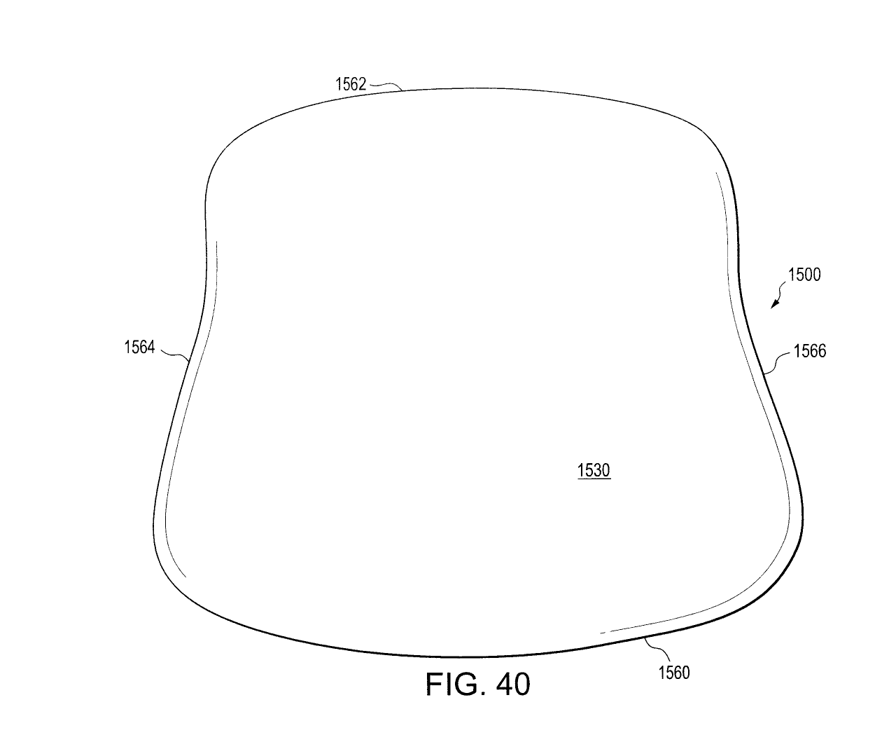

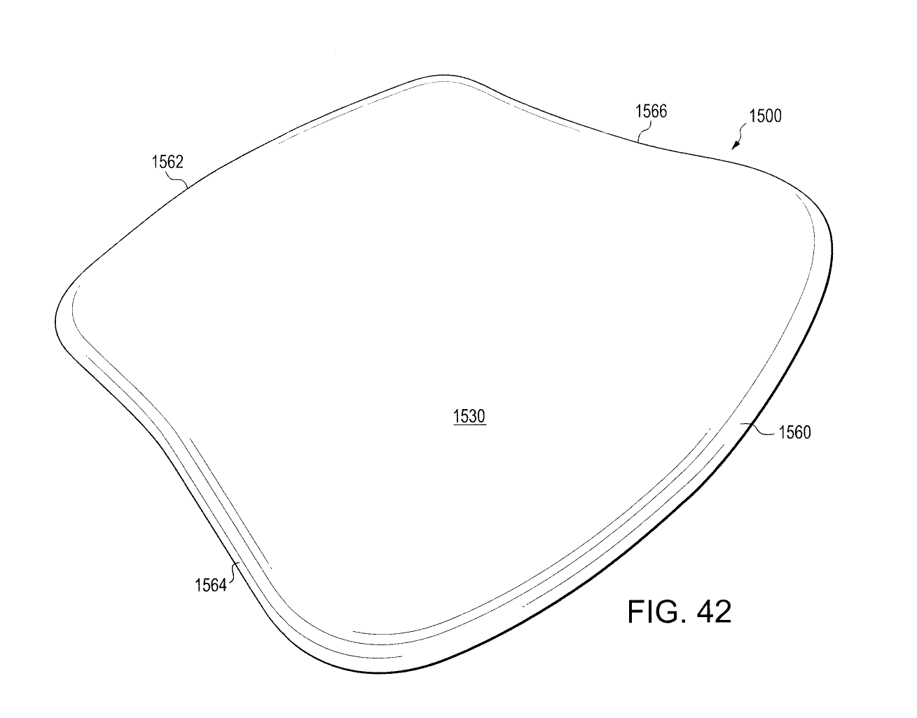

FIGS. 22 to 46 are views of various seat assemblies and components thereof. Specifically, FIGS. 22 to 28 illustrate a preferred embodiment seat cushion 1300 having a collection of downwardly projecting engagement members 1310 along its underside and a patterned surface along an opposite side. Upon placement on a chair or other seating unit, the patterned surface faces upward and the engagement members contact, and preferably engage, the seating unit. Specifically, the seat assembly 1300 as best shown in FIGS. 27 and 28 includes an intermediate layer 1330, a ring or frame assembly 1340 extending around the periphery of the intermediate layer 1330, and a layer of an outer decorative material 1350. The seat cushion 1300 includes a plurality of sides or outer peripheral regions such as regions 1360, 1362, 1364, and 1366 which, collectively, extend along the perimeter of the cushion 1300. In the preferred seat assembly 1300, the intermediate layer 1330 is formed from a vertically lapped fiber as described herein. A plurality of optional dimples 1320 may be formed along one or both faces of the seat cushion 1300.

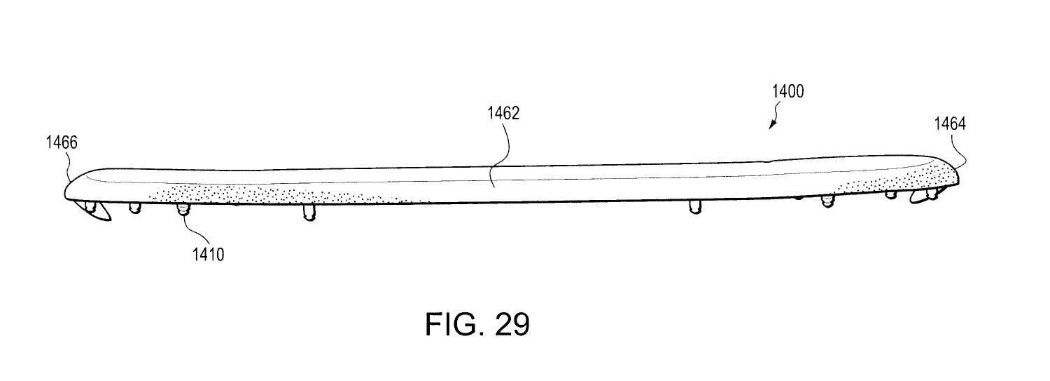

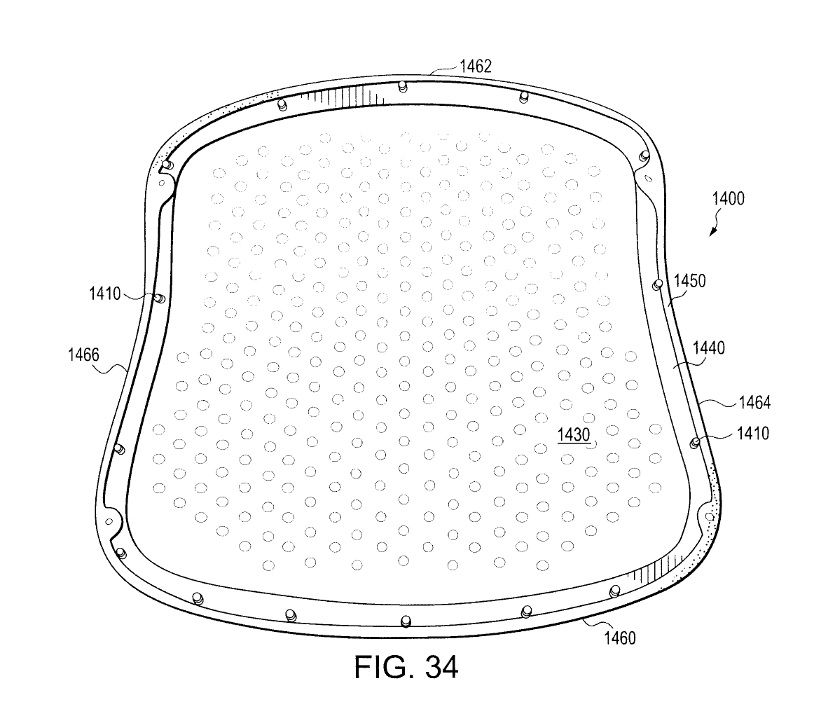

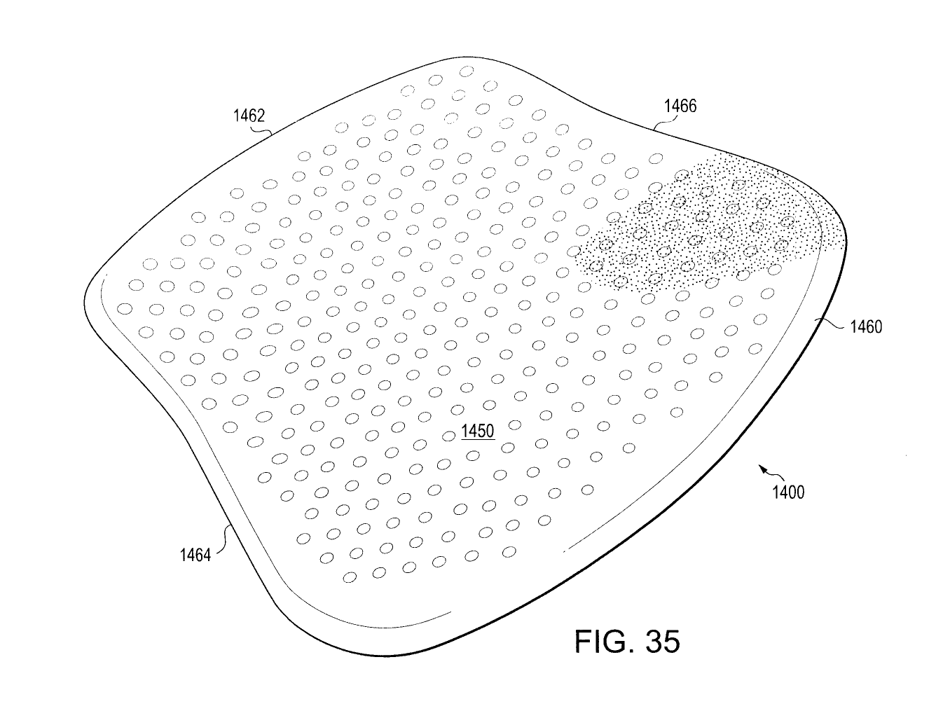

FIGS. 29 to 35 illustrate another preferred embodiment seat assembly 1400. The seat assembly 1400 also includes a collection of downwardly extending engagement members 1410 along its underside. Defined along its opposite side is a patterned surface. As best shown in FIGS. 34 and 35, the preferred embodiment seat assembly 1400 includes an intermediate layer 1430, a ring or frame assembly 1440 extending around the periphery of the intermediate layer 1430, and an outer decorative layer 1450. The seat cushion 1400 includes a plurality of sides or outer peripheral regions such as regions 1460, 1462, 1464, and 1466 which, collectively, extend along the perimeter of the cushion 1400. In the preferred seat assembly 1400, the intermediate layer 1430 is formed from a layer or region of a vertically lapped fiber as described herein, and another layer or region of a cushioning member. The layer or region of cushioning member may be disposed adjacent the side of the assembly 1400 facing upwards or downwards. The layer 1430 may define a plurality of optional dimples 1420.

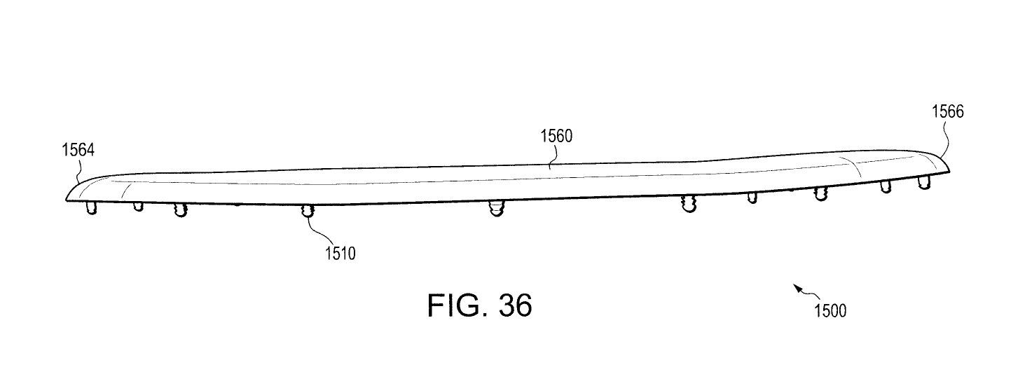

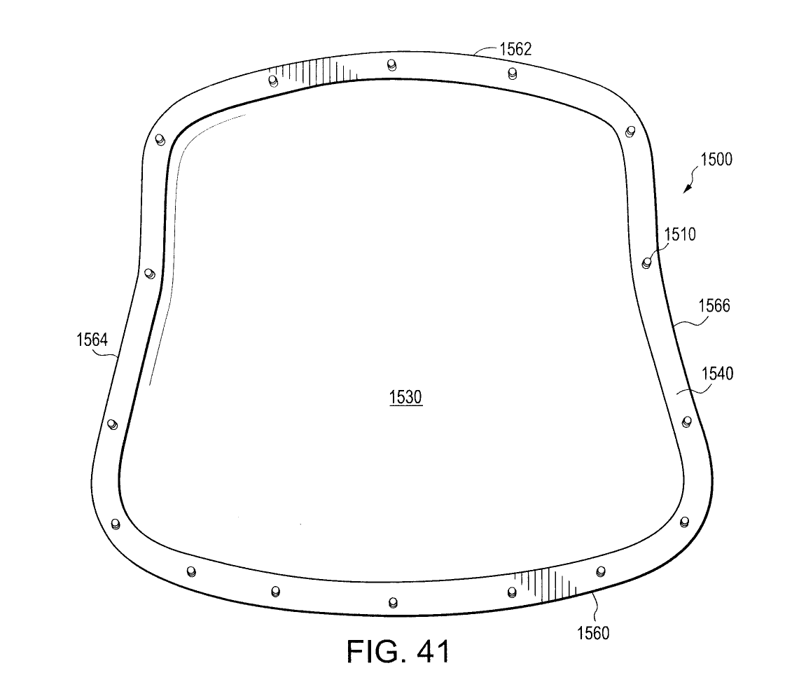

FIGS. 36-42 illustrate a seat assembly 1500 prior to application of a decorative outer layer such as outer layers 1350 and 1450 shown in the previously described assemblies 1300 and 1400. Specifically, FIG. 36 illustrates an intermediate layer 1530 having a ring or frame assembly with a collection of downwardly extending projection members 1510. The seat assembly 1500 includes a plurality of sides or outer regions such as regions 1560, 1562, 1564, and 1566 which, collectively, extend along the perimeter of the assembly 1500. FIG. 41 clearly shows a ring assembly 1540 with a collection of engagement members 1510 extending outwardly therefrom. The ring 1540 extends about the periphery of layer 1530. The intermediate layer 1530 preferably includes a region of vertically lapped fiber as described herein. The upward facing surface of the assembly 1500 is preferably free of any pattern such as a collection of dimples or other depressions or projections.

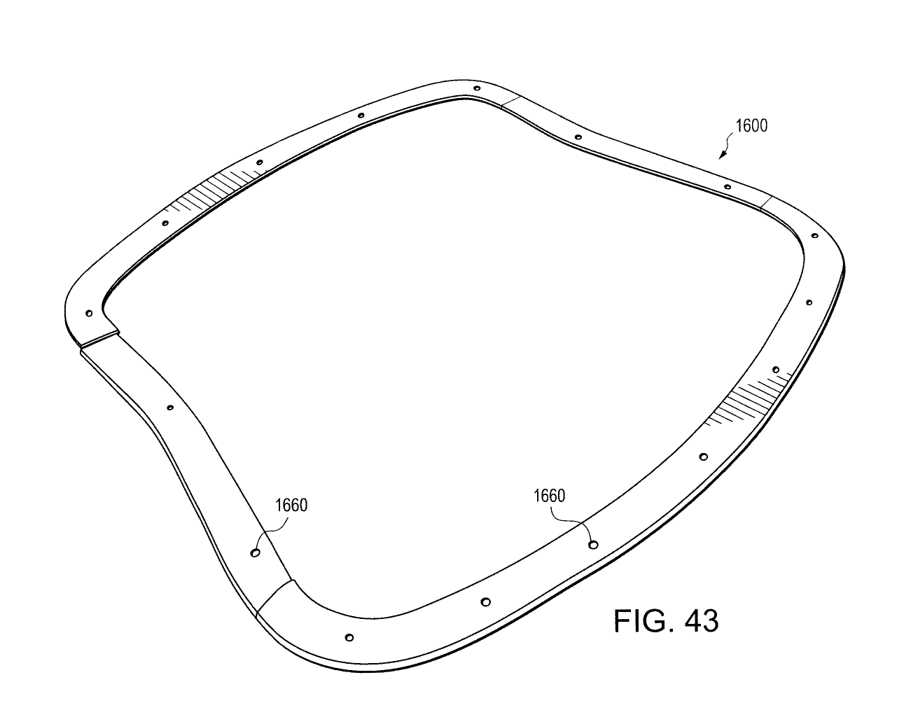

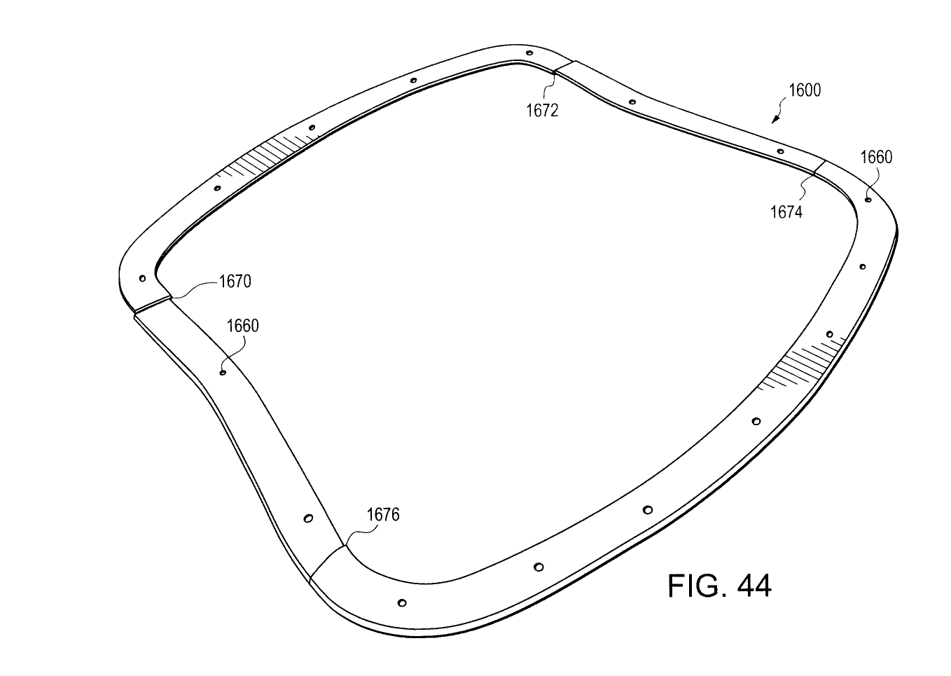

FIGS. 43 and 44 illustrate a preferred arrangement of components that are used to form a ring assembly 1600. Specifically, as shown in FIGS. 43 and 44, a collection of four subcomponents or pieces of ring assembly are arranged in a preferred pattern as shown in FIG. 43. Each of the pieces or members contain one or more apertures 1660. As shown in FIG. 44, preferably, a slight overlap is provided between adjoining end regions of each ring component. FIGS. 43 and 44 depict the ring assembly 1600 prior to molding. Upon molding the assembly, the overlap ensures contact and engagement between adjacent pieces. Specifically, in FIG. 44, overlap regions 1670, 1672, 1674, and 1676 are illustrated. In many applications it is more economical to form the ring assembly from a collection of smaller subcomponents rather than cutting or otherwise forming, and then shipping or storing, an entire unitary assembly.

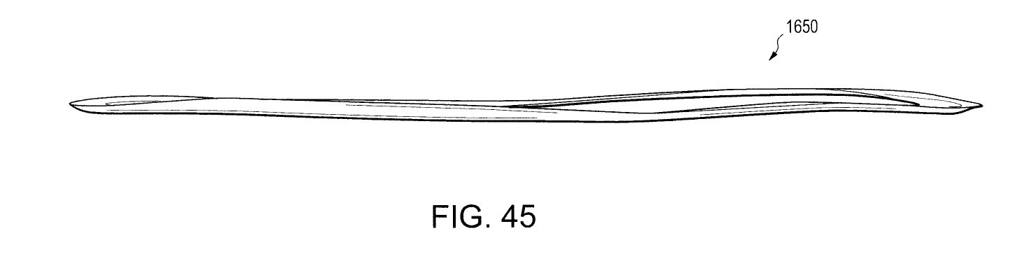

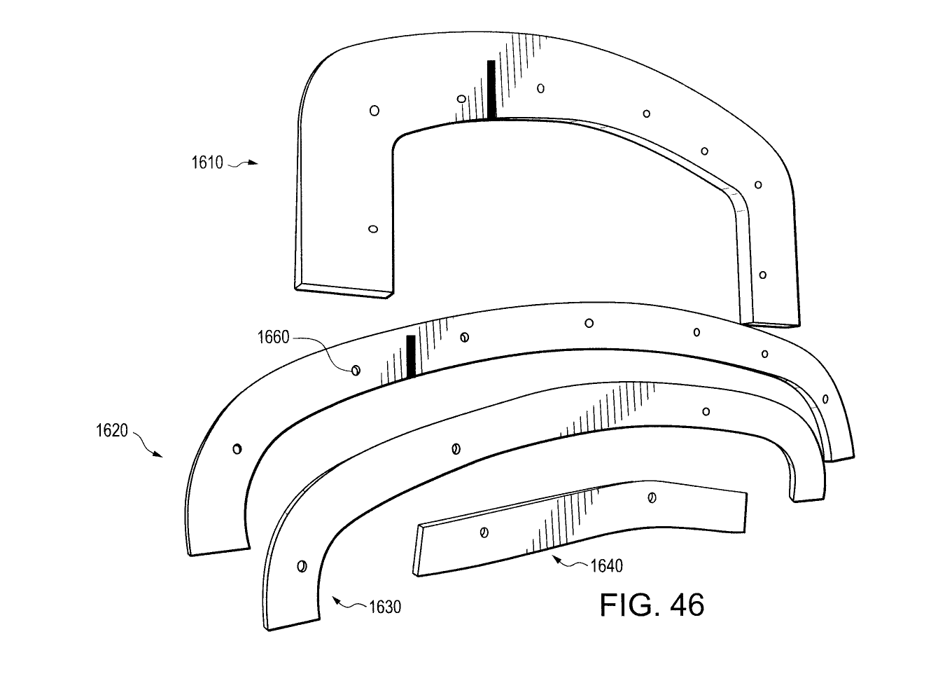

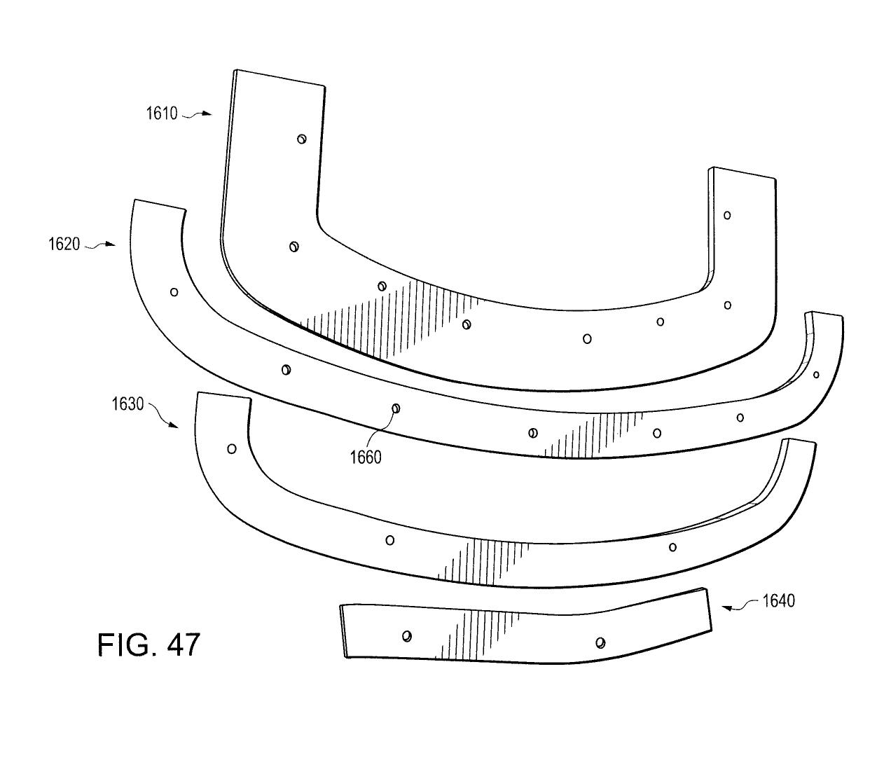

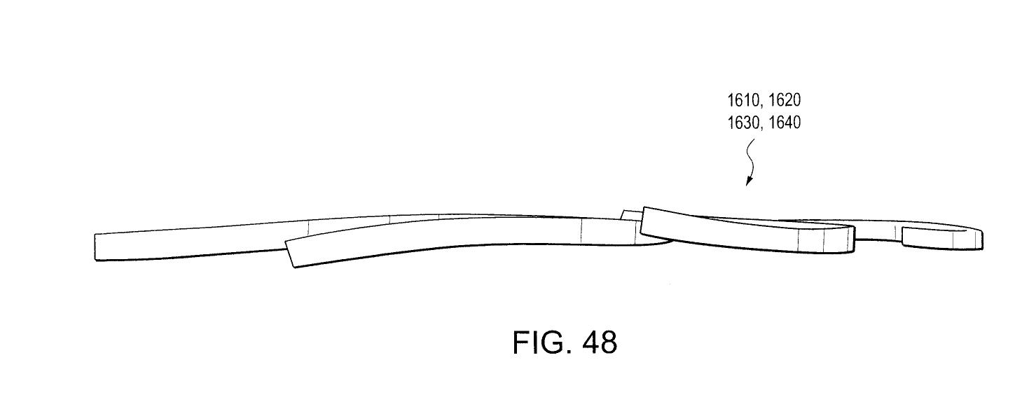

FIG. 45 illustrates the ring member 1650 after molding. The ring member now features a much thinner profile due to compression of the assembly. FIG. 46 illustrates the components 1610, 1620, 1630, and 1640 forming the ring assembly prior to molding. FIG. 47 also illustrates the components prior to molding. FIG. 48 illustrates the collection of ring assembly components prior to compression and arrangement, illustrating their relatively large thickness prior to compression. The ring assembly components can have a wide range of thicknesses, both prior to and after molding. In a preferred embodiment, the ring components exhibit a thickness of from about 0.7 to about 1.5 cm, and preferably about 1.0 cm. The ring after molding, preferably exhibits a thickness of from about 0.2 to about 0.6 cm, and preferably about 0.4 cm.

In alternative embodiments, the pad assembly is secured to the seating structure with adhesives, mechanical fasteners such as screws and the like, or combinations thereof. In one embodiment, an anchor member, such as a screw or the insert portion of the “Christmas tree” fastener is in-molded with the attachment portion extending from a rear or bottom side thereof. The attachment portion is received in mating holes (not shown) formed in the seating structure, for example with a snap-fit or by threading a nut thereon, so as to secure the pad to the seating structure.

Although the preferred embodiment seat cushions can be used in conjunction with nearly any mesh material forming a seat bottom, the preferred seat cushions of the invention are particularly adapted to be used in association with the chairs having a mesh seat bottom described and shown in one or more of the following patents or publications: U.S. Pat. Nos. 6,035,901; 6,702,390; 6,722,741; 6,726,286; 6,966,604; and 2004/0189073; all of which are hereby incorporated by reference.

The preferred seat cushion embodiment using a nonwoven batt of vertically lapped fibers can be utilized in other forms and applications, and is not necessarily limited to use with the frame and engagement members described herein. For example, after suitable embossing and/or compression using the heated tools as described herein, the resulting cushions (formed from a nonwoven batt of vertically lapped fibers) can receive a frame member formed about the cushion by injection molding. Alternately, the preferred cushions can be attached to a substrate or other seating surface by one or more mechanical fasteners. In addition, the cushions can be attached by welding heat, or adhesive strategies. Sonic welding, spin weld fasteners, or heat staked fasteners can be used.

The various seat cushions described herein can be used in a variety of different applications. For example, the cushions can be used in outdoor furniture, stadium seating, heavy equipment seating, bus seating, train seating, public transportation seating, motorcycle seating, recreational vehicle seating, off-road vehicle seating, agricultural equipment seating, and the like. Another application for which the seat cushions described herein can be used, is boating and related marine uses.

The invention has been described with reference to the preferred embodiments. Obviously, modifications and alterations will occur to others upon a reading and understanding of this specification. The invention is intended to include all such modifications and alterations.

1-24. (canceled)

25. A method of forming a seat cushion having a region of vertically lapped fibers, the method comprising:
forming a frame component by placing a thin layer of a moldable polymeric material into a first mold, and heating to thereby form the frame;
positioning the frame in a second mold in conjunction with a plurality of fasteners adapted to be molded to or otherwise affixed to the frame, and a layer of a nonwoven batt of vertically lapped fibers, and heating the frame, fasteners, and layer to thereby form an intermediate assembly; and
positioning the intermediate assembly into a third mold in conjunction with a layer of a covering material in position to cover a face of the intermediate assembly, and heating the intermediate assembly and covering material to thereby form the seat cushion.

26. The method of claim 25 wherein the first mold includes a plurality of outwardly extending projections to thereby form a plurality of openings in the frame component.

27. The method of claim 26 wherein the fasteners, prior to molding in the second mold, are at least partially extended through corresponding openings of the plurality of openings formed in the frame component.

28. The method of claim 25 wherein prior to heating the intermediate assembly and covering material, an effective amount of an adhesive is disposed between the assembly and the covering material.

29. The method of claim 25 wherein the nonwoven batt of vertically lapped fibers contains a majority of fibers extending in a direction approximately transverse to the plane of the batt.

30. The method of claim 29 wherein of the transversely extending fibers, at least 50% of their length extends in such direction.

31. The method of claim 30 wherein of the transversely extending fibers, at least 90% of their length extends in such direction.

32. The method of claim 31 wherein of the transversely extending fibers, at least 95% of their length extends in such direction.

33. The method of claim 25 wherein the layer of nonwoven batt of vertically lapped fibers is heated by heating the second mold to a temperature of from about 150° F. to about 375° F.

34. The method of claim 25 wherein at least one of the first mold, the second mold, and the third molds are heated to a temperature of from about 150° F. to about 375° F.

35. The method of claim 34 wherein all of the first, second, and third molds are heated to a temperature of from about 150° F. to about 375° F.

35. A method of forming a seat pad assembly having a region of vertically lapped fibers, the method comprising:
forming a rim component by placing a thin layer of a moldable polymeric layer into a first mold;
heating the first mold and moldable polymeric layer to thereby create a rigid rim component in the general shape of a seat perimeter;
forming a plurality of openings in the rigid rim component;
inserting fasteners in the plurality of openings in the rigid rim component;
placing additional moldable material on the rigid rim component in the second mold, the additional moldable material including vertically lapped fibers;
heating the second mold, the rigid rim component, and the additional moldable material to thereby form the seat pad assembly, whereby the fasteners are secured between the rigid rim component and the additional moldable material.

37. The method of claim 36 further comprising:
placing the seat pad assembly into a third mold and positioning a fabric cover with adhesive onto a top surface of the seat pad assembly;
heating the third mold, the fabric cover, the adhesive, and the seat pad assembly to thereby adhesively bond the fabric cover to the seat pad assembly.

38. The method of claim 36 wherein the second mold includes a heated tool which is contacted against the additional moldable material to compress and create select regions of varying strength and rigidity within the resulting seat pad assembly.

39. The method of claim 38 wherein areas of the seat pad assembly that are not contacted with the heated tool retain their cushioning characteristic.

40. The method of claim 38 wherein the tool is heated to a temperature of from about 150° F. to about 375° F.

41. The method of claim 40 wherein the tool is heated to a temperature of from about 200° F. to about 325° F.

42. The method of claim 38 wherein the heated tool is contacted against the additional moldable material for a time period of from about 60 seconds to about 90 seconds.

43. The method of claim 38 wherein the heated tool is contacted against the additional moldable material at a pressure of from about 15 psi to about 25 psi.
